(19) United States
(12) Patent Application Publication
(10) Pub. No.: US 2002/0054941 A1
(43) Pub. Date: May 9, 2002

(54) Methods and compositions to enhance tenderness and value of meat

(75) Inventors: Chris R. Calkins, Lincoln, NE (US); Jesus Pablo Velazco De La Garcia, Monterrey (MX); Nancy Coromoto Jerez-Timaure, Lincoln, NE (US)

Correspondence Address: ROTHWELL, FIGG, ERNST & MANBECK, P.C., 555 13TH STREET, N.W., SUITE 701, EAST TOWER, WASHINGTON, DC, 20004, US

(73) Assignee: The Board of Regents of the University of Nebraska, Lincoln, NE (US)

(21) Appl. No.: 09/852,762

(22) Filed: May 11, 2001

Related U.S. Application Data
(60) Provisional application No. 60/204,210, filed on May 12, 2000.

(51) Int. Cl. A23B 4/00

(52) U.S. Cl. 426/281; 426/641

(57) ABSTRACT

A method of enhancing the tenderness of meat for animal or human consumption by treatment of pre-rigor muscle with the compositions of the invention. It has been found that other quality meat traits can also be enhanced with the method of the invention.

This application is related to U. S. Provisional Application, Ser. No. 60/204,210, filed May 12, 2000, which is incorporated herein by reference.

### BACKGROUND OF INVENTION

The present invention relates generally to enhancement of desirable attributes of meat; compositions and methods for accomplishing such enhancement; and to the meat enhanced by such compositions and methods. More particularly, the present invention relates to the treatment of whole pre-rigor skeletal muscle, either while on the carcass or after excision, employing compositions of the invention which are applied to pre-rigor muscle to obtain a significant enhancement in tenderness and other desirable attributes of meat.

The publications and other materials used herein to illuminate the background of the invention, and in particular cases, to provide additional details respecting the practice, are incorporated by reference, and for convenience are referenced in the following text by author and date and are listed alphabetically by author in the attachments hereto.

Tenderness is reported to be the trait most affecting consumer acceptance of beef, while lean color is reportedly the most important attribute at point of purchase (Faustman and Cassens, 1991). Tenderness of meat is the sum total of the mechanical strength of skeletal muscle tissue and its weakening during postmortem aging of meat (Takahashi, 1996). Kamstra and Saffle (1959) described tenderness as an elusive characteristic because many of the factors which contribute to it are in a continual state of change from the time of animal slaughter. Much research during the past 50 years has been devoted to study of the numerous factors that have been implicated in tenderness, such as age, breed, sex, fatness, pre-slaughter treatments, dressing, cooling, storage and cooking procedures. The relationship between normal early-postmortem changes and tenderness have been investigated. The rate at which these changes occur influences important meat quality traits such as tenderness, color and water-holding capacity (Hamm, 1982).

The U.S. beef and pork industries have funded research to improve the quality, consistency and uniformity of beef. Much of this research has been directed to improvement through treatment of meat after it has gone through rigor mortis (post-rigor). There is an important difference between pre-rigor treatment and post-rigor treatment of meat. Several post-rigor treatments have been promoted as a way to enhance tenderness. The best known of these has been calcium chloride. This compound is reported to enhance the activity of proteolytic enzymes within meat that naturally improve meat tenderness upon extended cold storage (aging).

Previous work with sodium chloride was undertaken to reduce the sodium content of sausage-type (ground/processed) meat products. (Bernthal et al., 1989) The effects of sodium chloride on processing characteristics of the meat in sausage formulations has also been evaluated. However, the possible effect of sodium chloride on tenderness of whole and unground muscle has not been reported. Similarly, the use of glucose has been evaluated as a way to reduce the amount of sodium added to sausage ingredients. (Young et al., 1988) Dalrymple and Hamm (1974) showed that salt addition to pre-rigor muscle minces reduced phosphorylase activity. Phosphates have been used at levels of 1-2% to increase the amount of water bound by muscle, i.e., to improve water holding capacity, by increasing meat pH and solubilizing proteins (Bernthal et al., 1991). Alvarez (1996) and Martin-Herrera (1998) reported the use of sodium fluoride and calcium fluoride (200 mM) to inhibit enolase and improve tenderness by increasing pH in pre-rigor beef muscles.

Of the above attempts to alter attributes of pre-rigor muscle, each has disadvantages. For example, both salt and phosphate impart distinct flavor profiles and frequently alter color. Salt is also a pro-oxidant and its use increases oxidative rancidity and reduces color stability of meat. Use of phosphate is limited by law to 0.5% and, furthermore, it generates soapy flavors at high levels. Sodium acetate and sodium citrate have been added to meat to enhance shelf life. Citric acid sprays have been used as a surface spray for animal carcasses to inhibit microbial growth. Acid marination causes significant flavor changes and can alter the texture of the meat and make it mushy. Sodium fluoride has been reported to enhance tenderness and maintain fresh meat color, however, sodium fluoride is not approved in the U.S. for addition to meat products.

Most beef is cut into steaks and roasts, or ground for ground beef, after it has undergone a chilling process following harvest. This allows the normal rigor mortis (rigor) process to occur within muscle. One consequence of rigor development is production of lactic acid within the meat, resulting in a pH lower than pre-rigor muscle. Although the pH of different post-mortem muscle types can be quite different, meat of a given type which has a relatively higher pH is generally associated with an increased tenderization (Harrell et al.,1978; Watanabe et al.,1996; Beltran et al., 1997). The increased tenderness at high pH has been attributed by some to the direct effect of pH on the activity of the proteolytic enzymes which degrade the myofibrillar structure of the muscle (Yu and Lee, 1986). However, the results of investigations of the effect of pH on tenderness have been inconsistent. For example, Wulf et al. (1997), reports that higher pH (dark-cutting) beef is less tender.

Although there are reports of the beneficial effect of pH on tenderness of meat, high pH meat is quite dark in color and suffers severe loss in value as a consequence. However, as with studies of the correlation of pH and tenderness, the reported association of color with tenderness is inconsistent. Wulf et al. (1997) reported that dark-cutting beef is less tender. Conversely, Jeremiah et al. (1991) reported that beef carcass with dark color produced more tender steaks. Strategies to increase pH while preserving desirable color would be of importance to the industry.

Changes in another attribute of muscle, sarcomere length (SL), have been reported to be related to tenderness. Longer sarcomeres have been associated with greater tenderness (Hostetler et al., 1972; Bouton et al., 1973; Davis et al., 1979; Koohmaraie et al., 1996). Muscles shorten when they enter the rigor state. Temperature and pH also have been reported to play an important role in sarcomere length. Hertzman et al. (1993) showed that the rate of shortening increases with increasing temperature from 10° C. to 37° C. However, temperatures below 10° C. in more severe shortening (Honikel et al., 1981). Locker and Hagyard (1963) reported minimum shortening between 15 and 20° C. for sternomandibularis beef muscles.

Among muscle types, there are significant differences in the pattern of postmortem glycolysis and the onset of rigor (Ouali and Talmant, 1990). Meat quality attributes, including color, texture and tenderness, are also related to fiber characteristics of the muscle (Cassens and Cooper, 1971).

A method which enhances tenderness while maintaining desirable color of a wide spectrum of muscle types would upgrade the value, especially of lower-value cuts, and enhance customer satisfaction. It is desired to develop a treatment for beef which enhances tenderness of diverse muscle types, without over-tenderization. It is also desired to find a treatment to enhance tenderness which will not negatively impact meat color or flavor.

### SUMMARY OF INVENTION

The present invention relates generally to enhancement of desirable attributes of meat; compositions and methods for accomplishing such enhancement; and to the meat enhanced by such compositions and methods. More particularly, the present invention relates to the treatment of pre-rigor muscle, either while on the carcass or after excision, employing compositions of the invention which are applied to pre-rigor muscle to obtain a significant enhancement in tenderness and other desirable attributes of meat.

### BRIEF DESCRIPTION OF THE FIGURES IN ATTACHMENTS

FIG. 1 shows the effects of marination on pH and shear force in pre-rigor longissimus lumborum muscle.

FIG. 2 shows the effects of marination on pH and shear force in pre-rigor rectus abdominis muscle.

FIG. 3 shows the effects of marination on pH and shear force in pre-rigor cutaneous trunci muscle.

FIG. 4 shows effects of marination on visual color in pre-rigor longissimus lumborum muscle.

FIG. 5 shows effects of marination on visual color in pre-rigor rectus abdominous muscle.

FIG. 6 shows effects of marination on visual color in pre-rigor cutaneous trunci muscle.

### DETAILED DESCRIPTION OF THE INVENTION

The present invention relates generally to enhancement of desirable attributes of meat; compositions and methods for accomplishing such enhancement; and to the meat enhanced by such compositions and methods. More particularly, the present invention relates to the treatment of whole pre-rigor skeletal muscle, either while on the carcass or after excision, employing compositions of the invention which are applied to pre-rigor muscle to obtain a significant enhancement in tenderness and other desirable attributes of meat.

In accordance with the method of the present invention a composition is applied to pre-rigor skeletal muscle after harvesting and evisceration. The pre-rigor muscle may be manually or mechanically removed from the skeleton before application of the compositions of the instant invention. Alternatively, the entire carcass, or a portion thereof, could be used with the skeletal muscle fully or partially attached to the skeleton.

In one embodiment of the present invention, the method serves to enhance one or more quality meat traits. In a first aspect of this embodiment, the enhanced attribute is tenderness. In a second aspect of this embodiment, the attribute is reduced detriment in lean color. In a third aspect of this embodiment, the attribute is absence of off flavors. In a fourth aspect, the attributes include a combination of two or more of the above attributes.

In another embodiment of the invention, the means of application of the compositions of the present invention to pre-rigor muscle can be carried out by any of those means known in the art. In a first aspect of this embodiment, the compositions of the invention may be applied by direct injection into the muscle (pumping) when the muscle is on the carcass. In a second aspect of this embodiment, the compounds of the invention may be applied by direct injection after the muscle has been excised from the carcass. Injection may be accomplished by manual or mechanical means. In a third aspect of this embodiment, the compositions of the invention may be applied by marination of the muscle. In a fourth aspect, the compositions may be applied by injection into vein or artery, including infusion of the animal body. In a fifth aspect, application of the compositions of the invention may be augmented by high-pressure spray or vacuum system for delivering the compositions to the muscle. In a sixth aspect of this embodiment, the compositions of the invention may be applied by a combination of two or more of the above methods. Further details of suitable methods of application are set forth in the Examples.

Compositions useful in the practice of the invention include solutions of citric acid and its salts, glucose, sodium oxalate, oxamic acid, sodium acetate, and combinations thereof. It is preferred to use citric acid and/or one of its salts, most preferably sodium citrate. From a biochemical perspective, it is primarily though not exclusively the citrate portion of the molecule that directly or indirectly produces the enhancement in quality meat trait. The concentrations of the compositions useful in the practice of the invention can be determined in part by the degree of enhancement desired, and otherwise as dependent upon the method of application of the compositions of the invention to the muscle and the further processing strategies and products desired, as described elsewhere herein. The range concentrations of solutions, including the compositions of the invention is between about 0.1% to about 10% when the compositions are to be applied by injection of muscle and preferably 0.5% to 8%, most preferably 0.5% to 5%. When the compositions of the invention are applied by marination, it can be desirable to hasten uptake and therefore the range would in some cases be higher, between 0.1% and about 20%, preferably 0.5% to 15%. When the application is by infusion, the range would be between about 0.1% and about 15%.

The present invention will be described with reference to a variety of beef muscle types as the source of skeletal muscle. However, it is understood that this description is merely illustrative and the invention is applicable to muscle of any animal which is produced for human or animal consumption and to skeletal muscles of any mixture of muscle fiber types. From a manufacturing perspective, different muscle types and skeletal muscle of different species behave in a similar manner. For example, virtually all of the meat processing equipment in the industry works on meat from any species (with the possible exception of fish). The grinders, mixers, stuffers, and tumblers used in a poultry meat operation are often identical to equipment used for beef or pork. Thus, it is appropriate to extrapolate these results to all striated, skeletal muscle. Biochemistry of muscle is consistent across species to such an extent that the focus is on the few subtle differences rather than the similarities among muscle types. The post-mortem biochemistry of all striated, skeletal muscle is similar. They rely on glycolysis (the degradation of endogenous glycogen) to generate energy (ATP) within the muscle during rigor, thereby producing lactic acid and dropping muscle pH. The same biological structures exist—at both the cellular as well as the tissue level. Given the common biochemistry of striated skeletal muscles, similar results are to be expected with skeletal muscle, including, but not limited to, muscle of pork, lamb, poultry, deer, bison and llama. In a first aspect of this embodiment, the compounds may be used to enhance attributes of beef. In a second aspect of this embodiment, the compounds may be used to enhance attributes of pork. In a third aspect of this embodiment, the compounds may be used to enhance attributes of lamb. In a fourth aspect of this embodiment, the compounds may be used to enhance attributes of poultry. In a fifth aspect of this embodiment, the compounds may be used to enhance attributes of llama. In a sixth aspect of this embodiment, the compounds may be used to enhance attributes of deer. In a seventh aspect of this embodiment, the compounds enhance bison.

It is anticipated that the meat produced by the method of the instant invention can be used in a wide variety of meat products including, without limitation, meat products that are vacuum packaged, frozen and flaked, pre-cooked and steaks.

Definitions

The present invention employs the following definitions:

“Aging of muscle” refers to refers to the storage of meat or muscle foods at refrigerator temperatures.

“Enhanced tenderness” refers to the reduced shear force and/or increased desirability of taste panel tenderness ratings which occurs as a result of treatment.

“High pH” when referring to the ultimate pH value of muscle or meat means a pH (acidity) reading that is higher than that normally found in muscle or meat after the completion of rigor mortis.

“Hot boned” and “hot boning” refers to removal of meat from carcasses prior to rigor mortis.

“Lean color” refers to the ultimate color of meat after exposure to air and binding of oxygen to myoglobin which impart a bright, cherry red color to the meat. Lean color may be described in terms of redness, brightness, hue, and many other objective and subjective terms.

“Meat” shall include, without limitation, both cooked and uncooked meats irrespective of the state of rigor-mortis, and all edible meats, such as, for example, beef, pork, lamb, deer, bison, poultry and the like.

“Meat quality traits” refer to those characteristics of meat or muscle foods that influence the appearance, eating quality or processing quality of the meat or are indicative of such characteristics. Examples include color, tenderness, flavor, juiciness, and water holding capacity, among others.

“Meat texture” refers to the physical properties of meat and muscle relating to eating quality, including tenderness.

“Microbial stability” refers to the ability of the meat or muscle product to maintain micro-organisms at their current level and resist (or slow) excessive growth of spoilage micro-organisms.

“Muscle type” refers to the broad classification of striated, skeletal muscle into categories based upon their blend of muscle fiber type. Muscles are comprised of a mix of muscle fiber types. Each fiber (muscle cell) can be classified by several different systems as a particular type. One example of a classification system is red, intermediate, and white. Another is beta-red, alpha-red, and alpha white. Still others classify as type I, type IIA, and type IIB. Each system depends on specific biochemical and biophysical characteristics of the muscle. Skeletal muscles are comprised of a blend of muscle fiber types. Thus, whole skeletal muscles are often classified on the basis of the predominate nature of their fiber type profile. Those with many beta-red fibers might be considered “red” muscles while those with many alpha-white muscle fibers would be considered “white” muscles. This is an imperfect system because even the “white” muscles contain some beta-red fibers. Skeletal muscles exhibit characteristics that can be associated with one or more muscle fiber types, depending on the relative proportions of different muscle fiber types.

“Off-flavor” refers to a flavor not usually associated with fresh meat.

“Oxidation reduction potential” refers to the biochemical ability of the muscle/meat to counter oxidation through subsequent reduction of the oxidized compounds.

“Pre-rigor” refers to muscle that has not completed the process of rigor mortis or attained its ultimate, post-slaughter pH.

“Sarcomere length” or “SL” reflects the degree of muscle contraction present in the muscle.

“Shear force” refers to the amount of mechanical force needed to cut a core of meat; a standardized procedure to provide an objective measure of meat tenderness.

“Sodium citrate” is used herein to refer to citric acid and its salts, and includes sodium citrate, calcium citrate and other salts of citric acid. The USDA considers citric acid and its salts to be covered by the phrase, citric acid. (9 CFR §318.7)

“Tenderness of meat” refers to objective measures and/or subjective measure of the amount of force needed to cut or fragment cooked meat.

“Whole pre-rigor skeletal muscle” refers to striated skeletal muscle from animals used for meat.

The various embodiments of the present invention described herein are based on the discovery of compounds which enhance meat quality traits of all types of pre-rigor skeletal muscle. For example, sodium citrate was identified to enhance tenderness of muscle when used as a pre-rigor treatment. Similar effects were found with other compounds such as glucose, sodium oxalate, oxamic acid and sodium acetate. It has been discovered that pre-rigor muscles treated with these compounds were superior in tenderness to untreated muscle, despite a severe muscle shortening in excised muscle as evidenced by reduced sarcomere length. Particularly surprising was the magnitude of enhancement of tenderness with the compounds of the invention and that treated muscle color was affected to a lesser degree than it is in muscle where ultimate pH occurs naturally or after addition of other ingredients. Additional advantages with the use of the compounds of the invention are more desirable taste panel scores for juiciness, amount of connective tissue and flavor. Furthermore, sodium citrate is approved as a chemical preservative for addition to whole muscle products, cured products and as a surface application. ( 9 CFR §318.7(c)(4), Ch. 111 (1-1-100 Edition), U.S. Dept. Ag. (1998)).

Preliminary Trials

In several preliminary trials, pre-rigor beef muscle was tested for several quality meat traits after treatment by one of three procedures.

Homogenized Muscle

Pre-rigor beef muscle was homogenized 100 mL of treatment solution, held at 2° C. for up to 24 hours before testing pH and oxidation-reduction potential of the homogenate. The treatment solutions were as follows: sodium chloride (330 mM), sodium citrate (100 mM), sodium acetate (100 mM), iodoacetate (50 mM), oxamic acid (50 mM), glucose (330 mM), sodium diphosphate (100 mM), sodium fluoride (100 mM), sodium oxalate (50 mM), calcium iodate (50 mM), calcium chloride (300 mM), and water (control). All treatments except calcium chloride produced higher pH than the control. Two of the compounds are approved food ingredients; however, iodoacetate, oxamic acid, sodium oxalate and calcium iodate have toxic specifications and regulatory limits.

Sectioned Muscle

Pre-rigor beef muscle was sectioned into 100 g. samples at approximately 3 hours post-mortem. The pieces were injected with 10 mL of treatment solution followed by marination in the solution for 24 hours at 2° C. before testing pH and recording visual color of the muscle sections. For evaluation of shear force, samples were thawed, cooked, sliced (approximately 6 mm by 6 mm) and then cooled before readings were taken. The solutions used for this procedure were as described above for homogenized muscle.

Contrary to results suggested with the homogenized muscle trials, not all treatments resulted in higher pH than the control. Furthermore, results from different muscle types varied widely as to shear force values as compared to the control. However, the sectioned muscle itself was very thin with high connective tissue content, which made it difficult to obtain accurate results for shear force. Most of the treatment solutions used in these procedures caused different responses among muscle types.

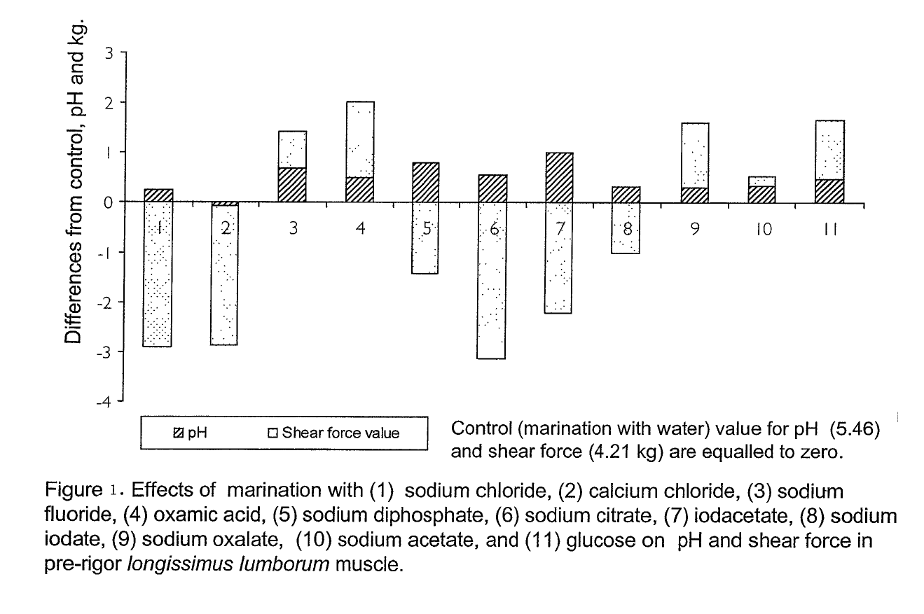

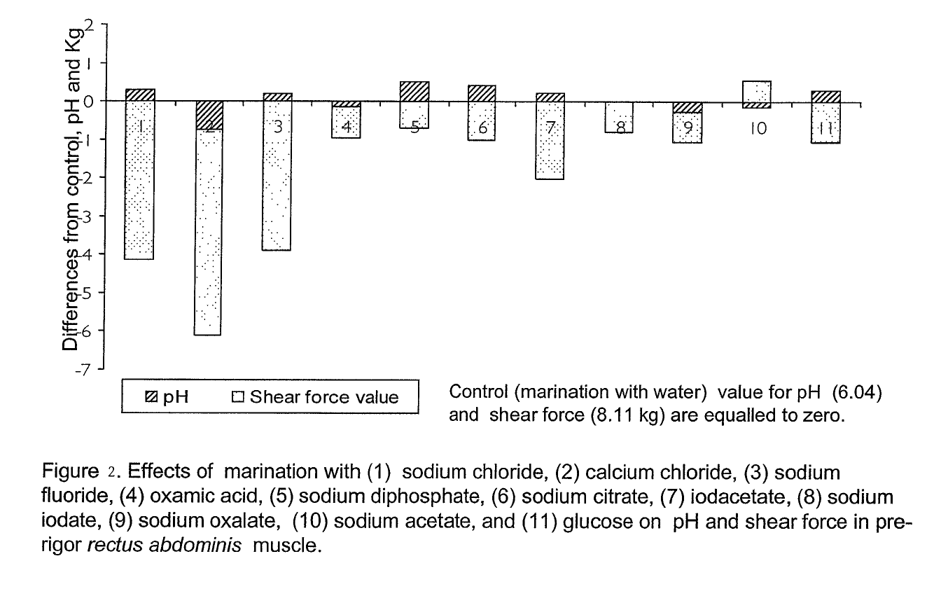

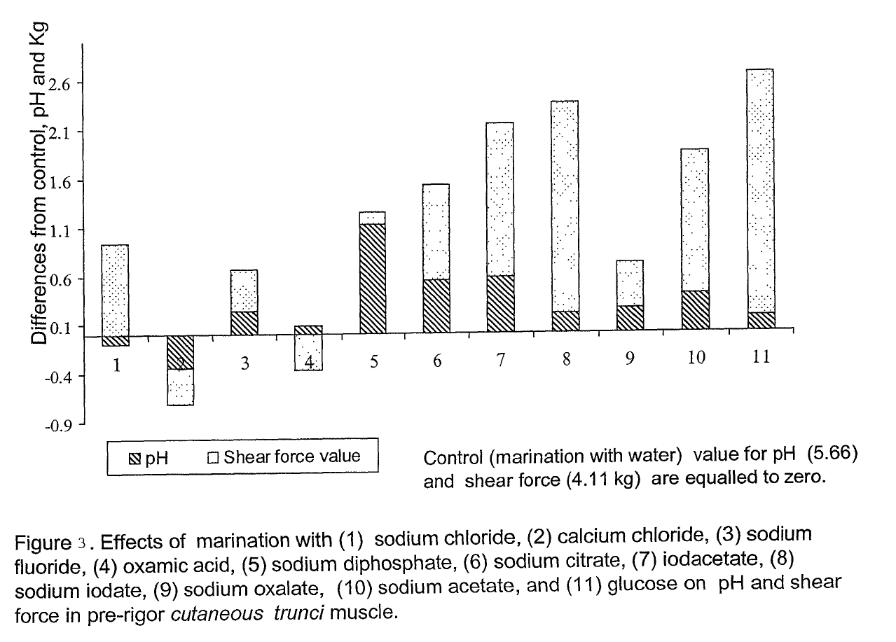

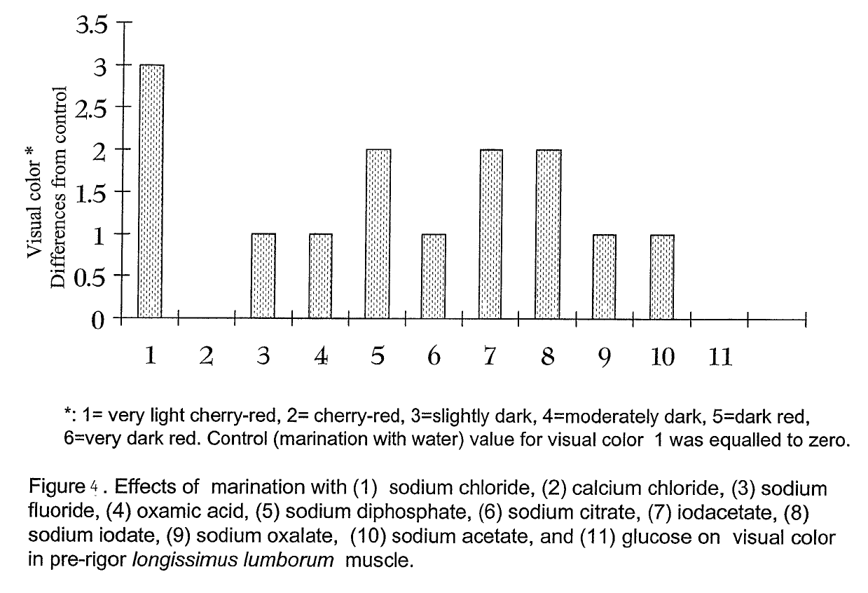

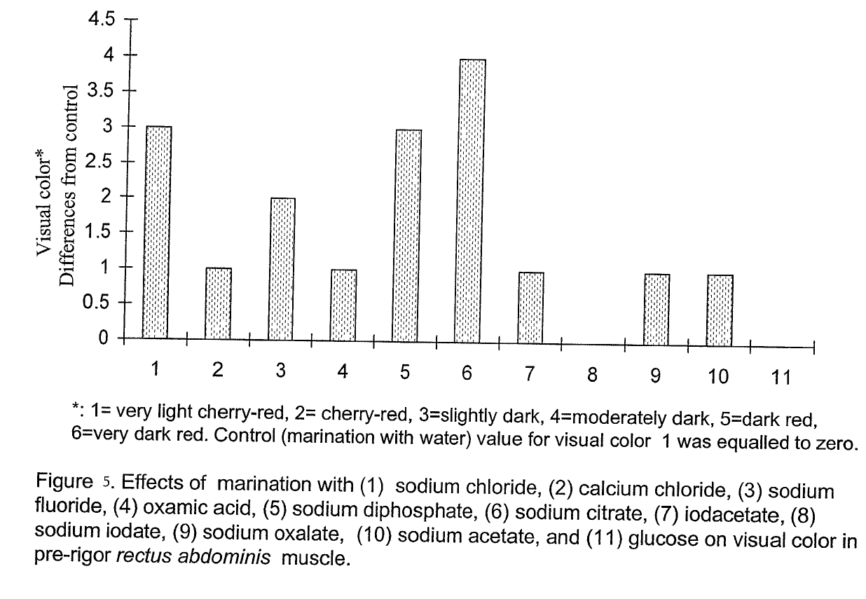

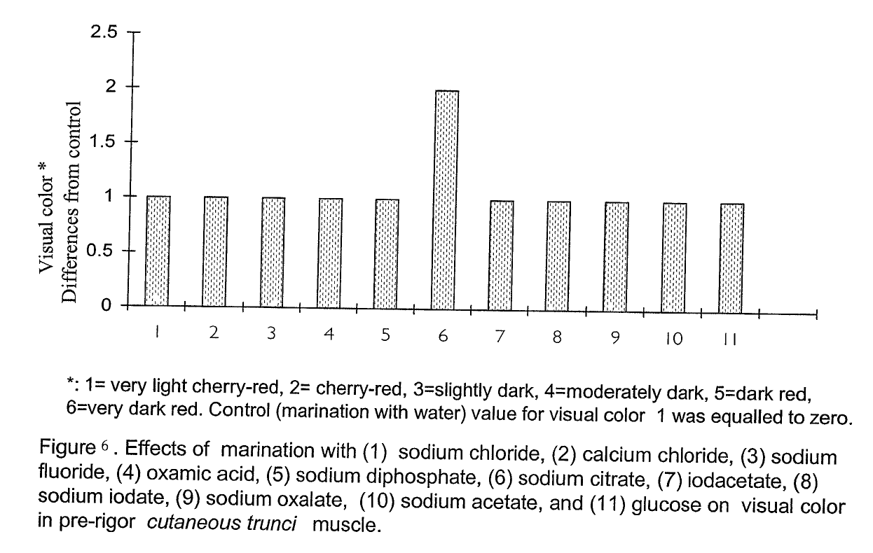

(FIGS. 1-6)

Sectioned Muscle

Pre-rigor beef muscle was sectioned and the sections were injected at approximately 1 hour post-mortem with a volume of treatment solution equal to 10% of the muscle weight. Objective color measurements were taken on pieces of each muscle section and the pieces were then frozen, powdered and stored at −80° C. for up to 10 days before testing pH and analyzing oxidation-reduction potential. Shear force was evaluated as described immediately above. Solutions used in this procedure were as follows: sodium citrate (200 mM), sodium acetate (200 mM), glucose (300 mM), calcium citrate (200 mM), calcium chloride (300 mM), injection with water, and no injection (control). The calcium citrate solution was prepared as a suspension using 0.25% carrageenan and 200 mM calcium citrate due to its insolubility in water. However, use of calcium citrate can be optimized by increasing solubility by means known in the art. Results are shown in Tables 1 and 2.

Muscle samples used in the preliminary trials underwent considerable physical manipulation prior to application of treatments and assessment of results. Excised muscles were either homogenized in a blender or cut pre-rigor into subsamples for application of the various treatments. This much manipulation would be expected to accelerate post-mortem metabolism. As a result, it was not possible to reliably predict the effect of treatment with the compositions of the invention on whole skeletal muscle when it was treated, pre-rigor, before homogenizing or sectioning. Given the significant disruptions in the processes which muscle would normally undergo, which were caused by the homogenization and removal pre-rigor of small samples for treatment and testing in the preliminary trials, it was not possible to predict how treatment of whole skeletal muscle (as compared to homogenized or sectioned) with the several compounds, would affect tenderness or other meat quality traits. Furthermore, the preliminary trials indicated that different muscle types responded differently to treatment and that use of different compounds would therefore be required. Specifically, the following differences from screening of compounds using sectioned or homogenized muscle pieces, which were among those observed when the method of the present invention was used to treat whole pre-rigor muscle:

1 ) Treatment of whole muscle with sodium citrate produced much lower shear force values than treatment of sectioned samples of flank muscle.

2) All whole muscle types treated with sodium citrate responded similarly while sectioned muscle samples responded inconsistently.

3) Surprisingly, no significant differences in oxidation/reduction (redox) potential were detected among types of treated whole muscle. Based on results of the preliminary trials of sectioned muscle samples, differences in redox potential among muscle types was anticipated.

4) No changes in lightness (L*) of whole muscle were anticipated contrary to treatment of sectioned muscles.

It has been discovered that, with the method of the present invention wherein pre-rigor whole muscle is treated, citric acid and its salts, glucose, sodium oxalate, oxamic acid and sodium acetate reduce the pH decline normally observed; rather than having the pH drop to approximately 5.6, the ultimate (post-rigor) muscle pH is higher.

TABLE 1
Effect of pre-rigor injection on pH, oxidation-reduction potential and shear force
of sternomandibularis beef muscles.

| | Variable | | | | |
|---|---|---|---|---|---|
| | | | | Redox | Shear |
| | PH | pH | Redox potential, | potential, mV | force, kg |
| Treatment | (0 h) | (72 h) | mV (0 h) | (72 h) | (72 h) |
| Calcium chloride | 6.77 | 5.88^{d} | 131.00 | 139.95 | 6.61^{a} |
| Glucose | 6.81 | 5.82^{cd} | 128.91 | 141.31 | 13.70^{b} |
| Sodium citrate | 6.86 | 5.77^{bc} | 135.45 | 152.40 | 11.09^{ab} |
| Sodium acetate | 6.86 | 5.80^{cd} | 128.98 | 131.88 | 9.88^{ab} |
| Calcium citrate | 6.92 | 5.82^{cd} | 128.70 | 126.60 | 7.57^{a} |
| Control Water | 6.95 | 5.66^{ab} | 127.51 | 141.76 | 14.44^{b} |
| Control no-water | 6.84 | 5.65^{a} | 135.60 | 145.30 | 14.03^{b} |
| SD | .04 | .03 | 4.04 | 4.21 | 1.44 |

^{a,b,c,d}means bearing the same letters within a column are not significantly different at P < .05.

TABLE 2
Effect of pre-rigor injection on color of sternomandibularis
beef muscles.

| | Variable | | | | |
|---|---|---|---|---|---|
| | L*value^{x} | a*value^{y} | b*value^{z} | L*value | a*value |
| Treatment | (0 h) | (0 h) | (0 h) | (72 h) | (72 h) |
| Calcium | 27.53 | 17.03 | 3.16 | 27.75 | 22.90 |
| chloride | | | | | |
| Glucose | 27.86 | 19.26 | 4.29 | 27.57 | 27.53 |
| Sodium citrate | 24.27 | 23.82 | 5.16 | 30.83 | 25.10 |
| Sodium acetate | 23.60 | 20.17 | 4.69 | 28.64 | 21.26 |
| Calcium citrate | 27.37 | 20.41 | 3.89 | 29.05 | 25.27 |
| Control Water | 28.07 | 19.03 | 3.82 | 28.05 | 24.65 |
| Control | 26.45 | 17.08 | 2.57 | 27.01 | 22.51 |
| no-water | | | | | |
| SD | 1.69 | 2.22 | .72 | 2.18 | 1.12 |

Comparison within a column are not significantly different (P < .05).
^{x}L* = lightness; 100 = white, 0 = black.
^{y}a* = redness; −80 = green, 100 = red.
^{z}b* = yellowness; −50 = blue, 70 = yellow.

### EXAMPLES

The following examples are illustrative of the present invention and are not intended to limit the scope of the invention. Standard techniques well-known in the art or the techniques specifically described below are utilized.

### Example 1

### Pre-rigor Injection of Whole Muscle

Experiment were conducted to test the effects of pre-rigor injection of several compounds. Effects of these compounds on pH, color, tenderness and other related traits of low-value beef cuts were investigated. Ten steers (22 to 24 mo of age, 515 to 676 kg live weight) were slaughtered according to current industry procedures. Pre-rigor semimembranosus (from the round), triceps brachii and supraspinatus muscles (from the chuck) were excised, after evisceration (approximately 1 hour post-mortem), from both sides of the carcass. Muscle sections were randomly assigned to the treatments: sodium citrate (NaC; 200 mM), sodium fluoride (NaF; 200 mM), sodium acetate (NaA; 200 mM), and calcium chloride (CaCl₂; 300 mM). The control samples remained on the carcass at 2° C. for 24 hours to simulate commercial conditions. Following a cooling, control muscles were removed from each carcass (4 replicates), vacuum packaged and transferred to the holding cooler with the other cuts at 2° C. Calcium chloride treatment was included to be compared with the other treatments.

At 2 hours post-mortem, each muscle was injected with a volume equal to 8% of the muscle weight using a four-needle hand injector. The temperature of solutions were 4° C. Each muscle was individually treated (2% of solution was added to give a total of 10% of muscle weight) and tumbled in a 75-pound capacity tumbler (Röschermatic, Oshabrück, Germany) for 30 min to insure uniform distribution of the solution.

Samples of each muscle (approximately 100 g) were taken at 0 hour (before injection), 24, and 72 hours after injection for determination of pH, oxidation-reduction potential, glycogen content, R-values, NAD, and NADH. The samples were then immediately frozen in liquid nitrogen and stored at −80° C. until they were powdered and analyzed. Fresh muscle samples (approximately 20 g) were taken at 72 hours after injection and assayed immediately for water holding capacity and sarcomere length. Evaluation of all traits before injection (0 hour), indicated that initial characteristics of all meat types were similar at the beginning of the experiment.

Sodium citrate (NaC) treatments enhanced muscle tenderness in whole pre-rigor muscle of all muscle types, without detriment to lean color and maintained a pH which was higher than the control. (Tables 3, 7, and 11) Injection of NaC in Triceps brachii produced the most tender meat (P<0.05) at 3 days. Tenderness also improved with CaCl₂ during aging; however, differences were of lesser magnitude (P<0.05) after 7 days and not significant by day 14. The same trend was observed in semimembranosus with no significant differences. Injection of NaC, CaCl₂, and NaF in supraspinatus significantly reduced shear force by 2.22 kg, 1.73 kg, and 1.15 kg (Table 8), respectively compared with controls at 3 days post-mortem, with no significant differences with these treatments at 7 days post-mortem. However, there was a significant increase in shear force with NaA treatment at 7 days post-mortem. Water holding capacity and L* value were not significantly affected by type of treatment. However, treated samples showed lower a* values than the controls of all muscles. Treatment did not affect oxidation-reduction potential, but all muscles became more oxidative (higher oxidation-reduction potential) after 3 days. Treated muscles had higher NAD and NADH content than controls (P<0.05); however this change did not affect lean color.

Triceps Brachii Muscle

All treated muscles had higher pH values and glycogen content than control (P<0.05) at 24 and 72 hours post-mortem, with those containing NaF and NaC having the highest values at both sampling periods (Table 3). These results provide clear evidence that postmortem glycolysis was in fact inhibited. R-value is the ratio of hypoxanthine to nucleotide concentrations, which indicates the state of rigor mortis (Honikel and Fischer, 1977). It was not possible to determine if muscle sections with any treatment entered rigor in advance of the control because no differences were detected in R-values at any sampling periods, indicating that after 24 hours, all muscles were in similar stages of rigor. No differences in water holding capacity (WHC) were observed despite differing pH values, perhaps because treated muscles contained 10% added liquid. Sarcomeres were shorter with all treatments than with the control (Table 4). Despite muscle shortening, triceps brachii muscles treated with NaC were (P<0.05) more tender after 3 days postmortem than the control (Table 4). Improvement in tenderness was also observed in samples treated with NaF or CaCl₂ Treatment with NaF and CaCl₂ affected shear force value; however, the affects were of lesser magnitude (P<0.05) after 7 days of aging than after 3 days and not significant by day 14. It is notable that treatment with NaC resulted in lower shear force values than CaCl₂ at day 7. Samples treated with NaA did not improve in tenderness and the pH was significantly lower at 24 and 72 hours than samples containing NaC or NAF.

It is desired to maintain an elevated pH without compromising color. Treatments did not affect L* and b* values (P>0.05). There were slightly, but significantly (P<0.05), lower a* values for treated muscles (Table 5) compared to the control at 72 hours. This may suggest a dilution effect due to the addition of 10% of muscle weight as the treatment solution. Reducing conditions (redox potential), NAD and NADH content were characterized among treatments because they are likely to affect color. Glycolytic inhibitors (NaA, NaC and NaF) resulted in the highest NAD concentration at 24 and 72 hours post-mortem (P<0.05), but these differences were not of sufficient magnitude to be reflected in redox potential. All samples showed the trend of decreasing reducing capacity (higher mV values) over time (Table 6). No differences were found in NADH content during treatments.

Supraspinatus Muscles

Samples treated with NaF or NaC had higher pH (P<0.05) than the control at 24 hours(>6.0) and 72 hours(>5.8). Those two treatments also had higher glycogen content (P<0.05 only at 72 hours). These results provide evidence that glycolysis was inhibited. As expected, WHC increased in muscles with higher pH, but these differences were not significant (Table 7). Similar to results found in triceps brachii, no differences were detected in R-values at any sampling periods.

Sarcomere lengths of treated muscles were shorter than that of the controls (P<0.05) at 72 hours. However, injection of NaC, CaCl₂, or NaF in pre-rigor supraspinatus reduced shear force values by 2.22 kg, 1.73 kg, and 1.15 kg, respectively, compared with the controls at day 3 (Table 8). Tenderness improved over time, however, no differences were detected (P>0.05) between treated samples and the controls after 7 days aging.

Muscles injected with NaF had the lowest a* values (less red) and b* values (less yellow) than control (Table 9) at 24 and 72 hours. Although not significant, NaC and NaA treated samples were also less red and yellow than the controls. Treatments affected neither reducing potential nor NADH content, however a slight, but significant, difference in NAD was detected in treated samples. Treated samples had higher NAD content than the controls.

Semimembranosus Muscles

Muscles treated with NaF or NaC had elevated pH values and greater glycogen content than the controls at 24 and 72 days postmortem. R-values indicated that muscles injected with NaF entered rigor more rapidly (showed a significant high R-value at 24 hours, Table 12) than the controls, indicating NaF arrested glycolysis for at least 3 days.

All treated samples had shorter sarcomere length than the control at 72 hours post-mortem (Table 12). The shortest sarcomere length was observed in samples injected with CaCl₂ (1.48 μm) and NaF (1.53 μm). The same tenderizing effects of NaF and NaC found in supraspinatus and Triceps brachii samples were observed in semimembranosus samples. Significant differences between treatments were not detected (P>0.05).

Different treatments did not significantly affect L* values, but treated samples were less red (lower a* values) and less yellow (lower b* values) than controls at 72 hours post-mortem. All treated samples showed a decreasing reducing capacity (higher mV values) over time (P<0.05). Treated samples also had significantly higher NAD and NADH content than the controls at 24 and 72 hours post-mortem. It was noticed that NaA produced the lowest reducing capacity and the highest NAD and NADH content (P<0.05).

TABLE 3
Effect of pre-rigor injection on pH, water holding capacity and glycogen content of
triceps brachii beef muscles.

| | Treatment | | | | | |
|---|---|---|---|---|---|---|
| | | Calcium | Sodium | Sodium | Sodium | |
| Variable | Control^{f} | chloride^{g} | acetate^{h} | fluoride^{h} | Citrate^{h} | SE |
| pH, 0 h | — | 6.77 | 6.78 | 6.76 | 6.71 | .03 |
| pH, 24 h | 5.61^{c} | 5.84^{b} | 5.80^{b} | 6.07^{a} | 5.97^{a} | .05 |
| pH, 72 h | 5.28^{d} | 5.67^{b} | 5.48^{c} | 5.95^{a} | 5.72^{b} | .04 |
| WHC, 72 hⁱ | 33.66 | 40.09 | 36.36 | 35.27 | 37.76 | 1.10 |
| Glycogen, 0 h^{j} | — | 39.14 | 49.53 | 48.22 | 38.74 | 3.62 |
| Glycogen, 24 h^{j} | 30.88^{b} | 28.76^{b} | 28.74^{b} | 43.98^{a} | 32.93^{b} | 2.78 |
| Glycogen, 72 h^{j} | 19.66^{c} | 25.01^{bc} | 27.22^{b} | 37.30^{a} | 27.58^{b} | 2.26 |

^{a,b,c}means bearing the same letters within a row are not significantly different at P < .05.
^{f}muscles remained in the carcass at 2° C. for 24 h.
^{g}concentration: 300 mM; ^{h}concentration: 200 mM.
ⁱWater Holding Capacity, %.
^{j}μmol/g muscle.

TABLE 4
Effect of pre-rigor injection on R-value, sarcomere length and shear force of
triceps brachii beef muscles.

| | Treatment^{f} | | | | | |
|---|---|---|---|---|---|---|
| | | Calcium | Sodium | Sodium | Sodium | |
| Variable | Control | chloride | acetate | fluoride | citrate | SE |
| R-value^{g}, 0 h | — | .81 | .80 | .86 | .85 | .03 |
| R-value^{g}, 24 h | 1.27 | 1.31 | 1.31 | 1.28 | 1.30 | .02 |
| R-value^{g}, 72 h | 1.38 | 1.44 | 1.40 | 1.38 | 1.36 | .02 |
| Sarcomere length (μm) | 2.41^{a} | 1.31^{b} | 1.53^{b} | 1.41^{b} | 1.62^{b} | .11 |
| Shear force (kg), 3 d | 5.75^{ab} | 4.95^{bc} | 6.47^{a} | 5.18^{bc} | 4.54^{c} | .30 |
| Shear force (kg), 7 d | 4.16^{c} | 4.87^{b} | 5.96^{a} | 4.82^{b} | 4.20^{c} | .18 |
| Shear force (kg), 14 d | 4.01 | 4.07 | 4.67 | 4.09 | 3.69 | .27 |

^{a,b,c}means bearing the same letters within a row are not significantly different at P < .05.
^{f}see table 1, for treatments description.
^{g}R-value is the ratio of hypoxantine to nucleotide concentration (an indicator of rigor mortis).

TABLE 5
Effect of pre-rigor injection on color of triceps brachii muscles.

| | Treatment^{f} | | | | | |
|---|---|---|---|---|---|---|
| | | Calcium | Sodium | Sodium | Sodium | |
| Variable | Control | chloride | acetate | fluoride | Citrate | SE |
| L*value^{g}, 0 h | — | 21.61 | 17.72 | 20.76 | 22.22 | 1.22 |
| L*value^{g} 24 h | 28.94 | 28.34 | 28.37 | 29.58 | 28.52 | 1.01 |
| L*value^{g}, 72 h | 28.19 | 32.14 | 31.36 | 28.26 | 29.56 | 1.01 |
| a*value^{h}, 0 h | — | 18.08 | 15.70 | 16.23 | 14.38 | 1.59 |
| a*value^{h}, 24 h | 24.64 | 27.23 | 25.08 | 22.40 | 24.54 | 1.27 |
| a*value^{h}, 72 h | 25.26^{c} | 23.18^{ab} | 21.87^{ab} | 23.83^{bc} | 21.18^{a} | .71 |
| b*valueⁱ, 0 h | — | 3.45 | 2.88 | 3.17 | 2.89 | .27 |
| b*valueⁱ, 24 h | 6.56 | 7.10 | 6.55 | 6.05 | 6.56 | .28 |
| b*valueⁱ, 72 h | 6.50 | 6.22 | 6.38 | 6.39 | 5.73 | .23 |

^{a,b,c}means bearing the same letters within a row are not significantly different at P < .05.
^{f}see table 1, for treatments description.
^{g}L* = lightness; 100 = white, 0 = black.
^{h}a* = redness; −80 = green, 100 = red.
ⁱb* = yellowness, −50 = blue, 70 = yellow.

TABLE 6
Effect of pre-rigor injection on Redox potential and NAD-NADH content of
triceps brachii beef muscles.

| | Treatment^{f} | | | | | |
|---|---|---|---|---|---|---|
| | | Calcium | Sodium | Sodium | Sodium | |
| Variable | Control | chloride | acetate | fluoride | citrate | SE |
| Redox potential, 0 h | — | 120.37 | 121.10 | 128.27 | 122.63 | 1.56 |
| Redox potential, 24 h | 115.43 | 127.10 | 129.13 | 131.35 | 125.05 | 1.24 |
| Redox potential, 72 h | 131.18 | 134.35 | 139.27 | 139.78 | 133.65 | 2.06 |
| NAD, 0 h | — | .425 | .442 | .450 | .421 | .036 |
| NAD, 24 h | .067^{c} | .193^{b} | .258^{a} | .261^{a} | .269^{a} | .017 |
| NAD, 72 h | .052^{b} | .117^{a} | .141^{a} | .113^{a} | .146^{a} | .016 |
| NADH, 0 h | — | .080 | .087 | .078 | .093 | .004 |
| NADH, 24 h | .061 | .062 | .076 | .060 | .067 | .004 |
| NADH, 72 h | .044 | .052 | .059 | .055 | .051 | .004 |

^{a,b,c}means bearing the same letters within a row are not significantly different at P < .05.
^{f}see table 1, for treatments description.
Redox potential is expressed as mV.
NAD and NADH are expressed as μmol/g tissue.

TABLE 7
Effect of pre-rigor injection on pH, water holding
capacity and glycogen content of supraspinatus beef muscles.

| | Treatment^{f} | | | | | |
|---|---|---|---|---|---|---|
| | | Calcium | Sodium | Sodium | Sodium | |
| Variable | Control | chloride | acetate | fluoride | Citrate | SE |
| pH, 0 h | — | 6.75 | 6.81 | 6.72 | 6.73 | .04 |
| pH, 24 h | 5.58^{d} | 5.88^{c} | 5.85^{c} | 6.23^{a} | 6.04^{b} | .02 |
| pH, 72 h | 5.45^{c} | 5.54^{c} | 5.64^{c} | 6.09^{a} | 5.86^{b} | .06 |
| WHC^{g}, 72 h | 40.03 | 36.71 | 35.94 | 34.19 | 32.72 | 1.01 |
| Glycogen^{h}, 0 h | — | 37.98 | 42.83 | 45.49 | 45.18 | 5.49 |
| Glycogen^{h}, 24 h | 26.37 | 26.75 | 24.43 | 37.37 | 30.43 | 4.39 |
| Glycogen^{h}, 72 h | 16.79^{b} | 19.31^{b} | 18.10^{b} | 30.46^{a} | 22.65^{ab} | 2.92 |

^{a,b,c}means bearing the same letters within a row are not significantly different at P < .05.
^{f}see table 1, for treatments description.
^{g}Water Holding Capacity, %.
^{h}μmol/g muscle.

TABLE 8
Effect of pre-rigor injection on pH, water holding capacity and glycogen
content of supraspinatus beef muscles.

| | Treatment^{f} | | | | | |
|---|---|---|---|---|---|---|
| | | Calcium | Sodium | Sodium | Sodium | |
| Variable | Control | chloride | acetate | fluoride | citrate | SE |
| R-value^{g}, 0 h | — | .85 | .84 | .79 | .84 | .02 |
| R-value^{g}, 24 h | 1.28 | 1.26 | 1.30 | 1.28 | 1.27 | .02 |
| R-value^{g}, 72 h | 1.34 | 1.43 | 1.41 | 1.37 | 1.38 | .02 |
| Sarcomere length (μm) | 2.13^{a} | 1.30^{c} | 1.44^{bc} | 1.58^{b} | 1.46^{bc} | .11 |
| Shear force (kg), 3 d | 7.28^{ab} | 5.55^{c} | 7.85^{a} | 6.13^{bc} | 5.06^{c} | .49 |
| Shear force (kg), 7 d | 4.87^{b} | 4.84^{b} | 6.95^{a} | 4.80^{b} | 4.89^{b} | .28 |

^{a,b,c}means bearing the same letters within a row are not significantly different at P < .05.
^{f}see table 1, for treatments description.
^{g}R-value is the ratio of hypoxantine to nucleotides (an indicator of rigor mortis).

TABLE 9
Effect of pre-rigor injection on color of supraspinatus beef muscles.

| | Treatment^{f} | | | | | |
|---|---|---|---|---|---|---|
| | | Calcium | Sodium | Sodium | Sodium | |
| Variable | Control | chloride | acetate | fluoride | Citrate | SE |
| L*value^{g}, 0 h | — | 20.07 | 20.75 | 22.55 | 21.99 | 1.63 |
| L*value^{g}, 24 h | 29.61 | 28.41 | 31.37 | 28.71 | 29.88 | 1.34 |
| L*value^{g}, 72 h | 28.99 | 30.86 | 33.68 | 28.21 | 30.51 | 1.66 |
| a*value^{h}, 0 h | — | 18.44 | 15.69 | 15.23 | 17.50 | 1.26 |
| a*value^{h}, 24 h | 27.09^{bc} | 24.80^{bc} | 22.65^{ab} | 20.78^{a} | 22.83^{ab} | .89 |
| a*value^{h}, 72 h | 24.19 | 24.27 | 21.67 | 16.66 | 20.87 | 2.36 |
| b*valueⁱ, 0 h | — | 3.27 | 2.69 | 2.81 | 3.68 | .31 |
| b*valueⁱ, 24 h | 7.20^{b} | 6.60^{b} | 6.14^{ab} | 5.32^{a} | 6.29^{ab} | .32 |
| b*valueⁱ, 72 h | 6.26 | 6.37 | 6.16 | 5.41 | 5.59 | .25 |

^{a,b,c}means bearing the same letters within a row are not significantly different at P < .05.
^{f}see table 1, for treatments description.
^{g}L* = lightness; 100 = white, 0 = black.
^{h}a* = redness; −80 = green, 100 = red.
ⁱb* = yellowness, −50 = blue, 70 = yellow.

TABLE 10
Effect of pre-rigor injection on Redox potential and NAD-NADH
content of supraspinatus beef muscles.

| | Treatment^{f} | | | | | |
|---|---|---|---|---|---|---|
| | | Calcium | Sodium | Sodium | Sodium | |
| Variable | Control | chloride | acetate | fluoride | citrate | SE |
| Redox potential, 0 h | — | 122.45 | 121.53 | 124.17 | 124.37 | 2.04 |
| Redox potential, 24 h | 120.65 | 131.00 | 130.37 | 131.45 | 118.17 | 3.98 |
| Redox potential, 72 h | 132.20 | 133.47 | 134.90 | 136.70 | 125.05 | 3.98 |
| NAD, 0 h | — | .366 | .355 | .384 | .387 | .02 |
| NAD, 24 h | .091^{b} | .152^{ab} | .212^{a} | .216^{a} | .148^{ab} | .002 |
| NAD, 72 h | .037^{b} | .089^{ab} | .113^{a} | .078^{a} | .098^{ab} | .011 |
| NADH, 0 h | — | .074 | .073 | .078 | .073 | .006 |
| NADH, 24 h | .057 | .066 | .064 | .056 | .056 | .003 |
| NADH, 72 h | .043^{b} | .041^{ab} | .058^{c} | .045^{b} | .035^{a} | .002 |

^{a,b,c}means bearing the same letters within a row are not significantly different at P < .05.
^{f}see table 1, for treatments description.
Redox potential is expressed as mV.
NAD and NADH are expressed as μmol/g tissue.

TABLE 11
Effect of pre-rigor injection on pH, water holding
capacity and glycogen content of semimembranosus beef muscles.

| | Treatment^{f} | | | | | |
|---|---|---|---|---|---|---|
| | | Calcium | Sodium | Sodium | Sodium | |
| Variable | Control | chloride | acetate | fluoride | Citrate | SE |
| pH, 0 h | — | 6.76 | 6.75 | 6.70 | 6.68 | .03 |
| pH, 24 h | 5.54^{c} | 5.77^{b} | 5.70^{b} | 6.08^{a} | 5.97^{a} | .04 |
| pH, 72 h | 5.24^{e} | 5.60^{c} | 5.38^{d} | 5.97^{a} | 5.78^{b} | .04 |
| WHC^{g}, 72 h | 36.54 | 41.71 | 39.35 | 38.22 | 41.99 | 2.39 |
| Glycogen^{h}, 0 h^{h} | — | 58.18 | 64.24 | 62.90 | 65.12 | 3.59 |
| Glycogen^{h}, 24 h | 40.80^{b} | 45.90^{ab} | 40.88^{b} | 54.03^{b} | 52.83^{a} | 3.56 |
| Glycogen^{h}, 72 h | 25.86^{b} | 37.10^{ab} | 28.64^{b} | 43.77^{a} | 45.65^{a} | 4.27 |

^{a,b,c:}means bearing the same letters within a row are not significantly different at P <.05.
^{f.}see table 1, for treatments description.
^{g}:Water Holding Capacity, %.
^{h}:μmol/g muscle.

TABLE 12
Effect of pre-rigor injection on R-value,
sarcomere length and shear force of semimembranosus beef
muscles.

| | Treatment^{f} | | | | | |
|---|---|---|---|---|---|---|
| | | Calcium | Sodium | Sodium | Sodium | |
| Variable | Control | chloride | acetate | fluoride | Citrate | SE |
| R-value^{g}, 0 h | — | .83 | .82 | .85 | .83 | .02 |
| R-value^{g}, 24 h | 1.26^{b} | 1.28^{b} | 1.31^{ab} | 1.36^{a} | 1.28^{b} | .02 |
| R-value^{g}, 72 h | 1.36 | 1.45 | 1.39 | 1.42 | 1.38 | .03 |
| Sarcomere length | 1.82^{a} | 1.48^{c} | 1.74^{ab} | 1.53^{bc} | 1.72^{ab} | .07 |
| (μm) | | | | | | |
| Shear force (kg), | 6.56 | 6.28 | 6.61 | 6.02 | 5.14 | .46 |
| 3 d | | | | | | |
| Shear force (kg), | 4.90 | 5.36 | 5.78 | 5.56 | 4.41 | .43 |
| 7 d | | | | | | |
| Shear force (kg), | 4.06 | 4.03 | 5.08 | 4.60 | 3.96 | .38 |
| 14 d | | | | | | |

^{a,b,c:}means bearing the same letters within a row are not significantly different at P<.05.
^{f.}see table 1, for treatments description.
^{g:}R-value: is the ratio of hypoxantine to nucleotides (an indicator of rigor mortis).

TABLE 13
Effect of pre-rigor injection on color of semimembranosus beef muscles.

| | Treatment^{f} | | | | | |
|---|---|---|---|---|---|---|
| | | Calcium | Sodium | Sodium | Sodium | |
| Variable | Control | chloride | acetate | fluoride | Citrate | SE |
| L* value^{g}, 0 h | — | 20.49 | 18.94 | 20.58 | 20.22 | 1.51 |
| L* value^{g}, 24 h | 26.78 | 28.61 | 28.47 | 27.70 | 26.87 | 1.48 |
| L* value^{g}, 72 h | 29.15 | 29.44 | 32.06 | 27.06 | 30.19 | 1.08 |
| a* value^{h}, 0 h | — | 15.18 | 13.36 | 13.60 | 13.31 | 1.15 |
| a* value^{h}, 24 h | 26.99 b | 25.63^{b} | 24.56^{ab} | 22.54^{a} | 25.75^{b} | .92 |
| a* value^{h}, 72 h | 27.57^{b} | 24.88^{ab} | 20.99^{a} | 22.48^{a} | 21.38^{a} | 1.34 |
| b* valueⁱ, 0 h | — | 2.78 | 2.24 | 2.48 | 2.61 | .17 |
| b*valueⁱ, 24 h | 7.08^{c} | 6.83^{bc} | 6.34^{ab} | 5.89^{a} | 6.61^{bc} | .22 |
| b*valueⁱ,72 h | 7.10 | 6.58 | 5.86 | 5.99 | 5.84 | .39 |

^{a,b,c:}means bearing the same letters within a row are not significantly different at P<.05.
^{f}see table_, for treatments description.
^{g:}L* = lightness; 100 = white, 0 = black.
^{h:}a* = redness; −80 = green, 100 = red.
^{i:}b* = yellowness, −50 = blue, 70 = yellow.

TABLE 14
Effect of pre-rigor injection on Redox potential and
NAD-NADH content of semimembranosus beef muscles.

| | Treatment^{f} | | | | | |
|---|---|---|---|---|---|---|
| | | Calcium | Sodium | Sodium | Sodium | |
| Variable | Control | chloride | acetate | fluoride | Citrate | SE |
| Redox potential, | — | 120.10 | 122.35 | 125.95 | 124.55 | 1.95 |
| 0 h | | | | | | |
| Redox potential, | 118.65^{b} | 129.97^{a} | 134.20^{a} | 130.07^{a} | 128.85^{a} | 2.88 |
| 24 h | | | | | | |
| Redox potential, | 137.12^{abc} | 127.92^{c} | 142.75^{a} | 140.70^{ab} | 132.67^{bc} | 3.22 |
| 72 h | | | | | | |
| NAD , 0 h | — | .525 | .582 | .551 | .568 | .027 |
| NAD,24h | .113^{c} | .328^{ab} | .410^{a} | .281^{b} | .306^{b} | .029 |
| NAD,72h | .072^{c} | .118^{bc} | .192^{a} | .096^{c} | .173^{ab} | .022 |
| NADH, Oh | — | .126 | .124 | .130 | .121 | .009 |
| NADH, 24 h | .070^{a} | .073^{a} | .090^{b} | .098^{b} | .072^{a} | .004 |
| NADH, 72 h | .049^{a} | .054^{ab} | .079^{c} | .061^{ab} | .066^{b} | .004 |

^{a,b,c:}means bearing the same letters within a row are not significantly different at P<.05
^{f.}see table_, for treatments description.
Redox potential is expressed as mV. NAD and NADH are expressed as μmol/g tissue.

Evaluation of Shear Force, pH, Oxidation-reduction Potential, Sarcomere Length, Objective Color, Water Holding Capacity, Glycogen Content, R-value and Dinucleotide Results (Example 1)

Shear Force

Tenderness of samples was evaluated by measuring Warner-Bratzler shear force. Steaks (2.54-cm thick) from the middle of each muscle were cut and frozen at 3, 7 and 14 days postmortem. Frozen steaks (2.54 cm thick) were thawed at 4° C. for 24 hours and cooked on Farberware Open Hearth Broilers (Model 350A Walter Kidde, Bronx, N.Y.) to an internal temperature of 40° C., turned, and cooked to a final internal temperature of 70° C. (AMSA, 1995). Temperature was monitored using an OMEGA thermocouple thermometer type T (Omega Engineering, Inc., Stamford, Conn.) inserted into the geometric center of a steak. The cooked steaks were chilled 2 hours at 2° C., and then 8 cores (1.27-cm diameter) were removed parallel to the muscle fiber orientation. Cores were sheared once each on an Instron Universal Testing Machine model 55R1123 (Instron, Canton, Mass.) with a Warner-Braztler attachment. The Instron was set up with a 500 kg load cell, full scale load=1 (0-10 kg), and crosshead speed=250 mm/mim.

Muscle pH

Duplicate pre-rigor samples (5 g) were weighed from powdered sample and homogenized (Polytron, Brinkman Instruments, New York, N.Y.) in 50 mL of 5 mM iodoacetic acid, 150 mM potassium chloride (pH 7.0, 24° C.) to stop glycolysis (Ahn et al., 1992). The pH of the suspension was measured with a general purpose electrode (Corning Glass Works, Corning, N.Y.) attached to an Orion Model SA 720 pH meter (Orion Research, Inc., Boston, Mass.). Post-rigor muscle pH was determined by homogenizing 5 g of sample in 50 mL of deionized water (Winger et al., 1979).

Oxidation-Reduction Potential

Oxidation-reduction potential in meat may be influenced by addition of exogenous compounds (Rodel and Sheuer,1999) which may also cause color alterations in fresh meat. However, very limited information exists regarding redox potential of meat and its significance on lean color. Renerre and Labas (1987) reported that muscles with the most unstable color showed high reducing activities. In their study, redox potential in all muscles increased during storage (higher oxidizing capacity). Contrary to results presented herein, Anh and Maurer (1989) found that under normal conditions, redox potential in meat decreased during postmortem storage.

Duplicate, powdered samples (10 g) were weighed into a Waring blender cup and blended with 0.1 M phosphate buffer (pH 6.0, 24° C.). The blender cup lid had a hole cut with an attached vacuum hose to minimize oxygen incorporation during the 15 sec homogenization process. Samples were transferred to a plastic beaker and measured with a redox combination electrode #406080 (Corning Glass Works, Corning, N.Y.) attached to a pH meter (Orion Model SA 720 pH meter (Orion Research, Inc., Boston, Mass.). Reduction values of samples were read and recorded in absolute mV after a 2 min equilibration. This time is enough to get consistent and stable reduction potential value. Preliminary experiments revealed that 2 min was a sufficient amount of time to wait with the probe imbedded in the sample before taking readings with the redox probe.

Sarcomere Length

Sarcomere length was determined by the neon laser diffraction method (Cross et al., 1981). Fresh samples were taken at 72 hours after injection, cut into three cubes about 1-2 cm wide, making sure the fibers ran longitudinally, and fixed in 3% glutaraldehyde solution in 0.1 M phosphate buffer for approximately 4 hours. Glutaraldehyde solution was then replaced with 0.2 M sucrose solution. Cubes can be stored for up to 4 days at 2° C. in this solution. Muscle fibers were placed on a microscope slide with a drop of the sucrose solution. The diffraction bands were traced on paper, moving the slide around until a clear diffraction pattern was observed. From each cube, sarcomere length of eight fiber samples was determined (24 total measurements per observation). Sarcomere length was calculated using the distance (mm) between bands and the following formula:

$$Length ( μm ) = \frac{0.6328 \times D \times \sqrt{{( T \div D )}^{2} + 1}}{T}$$

D=distance from specimen to diffraction pattern screen in mm (100 mm).

T=spacing between diffraction bands in mm.

0.6328=wavelength of the laser

Objective Color

Color development, oxidation-reduction potential and NAD/NADH content in muscles treated with the compounds of the invention were evaluated. When meat is first cut, the primary color pigment (myoglobin) is in a deoxygenated state. This gives the meat a purple tinge. When exposed to air, the oxygen binds to myoglobin (forming oxymyoglobin), which gives a bright, cherry red color to the meat. When the meat is oxidized, it converts the oxymyoglobin to metmyoglobin—the brown color of meat. The more reducing equivalents present in muscle, the longer the time before the brown color appears.

Objective color readings were taken before injection and 24 and 72 hours after injection using a Hunter Lab Mini Scan XE Plus Model No. 451 O-L (Hunter Associates, Reston, Va.), with a 2.5 cm port, Illuminant A and 20° standard observer. It was zeroed with the black plate and standardized with a white plate. Three readings were taken over the entire muscle surface and then the average was calculated. Readings at 24 and 72 hours post-injection were taken after letting muscles bloom for 30 minutes. The L*, a*, and b* values were taken as indicators of lightness, redness and yellowness, respectively.

Water Holding Capacity

Expressible moisture was measured at 72 hours post-mortem following a centrifugal method described by Jauregui et al. (1981). Three pieces of Whatman #3 filter paper, 5.5 cm in diameter, were folded into a thimble shape over the outside of an inverted 16×150 mm test tube with the #50 filter paper as the internal surface thimble. The filter paper was weighed before and after addition of 1.5±0.3 g sample of muscle. The sample in the thimble was then centrifuged in a 50-mL centrifuge tube at 30,000×g for 15 min at 4° C. The sample was removed and the paper was reweighed. Water-holding capacity was expressed as percent weight lost from original sample and calculated using the following formula:

$$Expressible moisture ( \% ) = \frac{\begin{matrix}final paper weight - \\ initial paper weight\end{matrix}}{weight of sample} \times 100$$

Glycogen Content

Glycogen extraction was performed in duplicate with 3 g of frozen-powdered muscle sample, which was homogenized with 0.6 N perchloric acid. Amylo-α-1,4-α-1,6- glucosidase from Aspergillus niger (No. A3514. Sigma Chemical, St. Louis, Mo.) was used for the breakdown of the glycogen molecules to free glucose following the method described by Roehrig and Allred (1974). Homogenate was incubated for 2 hours at 37° C., then 100 μL of 3 N perchloric acid was added to precipitate the proteins. After centrifugation, the supernatant was stored at 0-4° C., until analyzed, which was within 2 weeks.

The assay for glucose was run as described by Dalrymple and Hamm (1973) and Roehrig and Allred (1974), using glucose-6-phosphate dehydrogenase (No. G8878. Sigma Chemical, St. Louis, Mo.) and hexokinase (No. H5500. Sigma Chemical, St. Louis, Mo.). Briefly, the method involves an exoglucosidase, Amylogucosidase, from Aspergillus niger which hydrolyses the -α-D-(1-4) and -α-D-(1-6)-linkages of glycogen. The glucose formed is specifically determined with hexokinase and glucose-6-phosphate dehydrogenase. The glucose liberated after hydrolysis of glycogen is proportional to the increase of absorbance measured at 340 nm. Fifty μL of sample was incubated with 1 mL ATP, NADP, Glucose-6-phosphate dehydrogenase buffer and 5 μL hexokinase at 37° C. for 15 min. Absorbance was measured at 340 nm wavelength, light path=1 cm. The muscle glycogen content was calculated with the following formula: Glycogen (μmol glucose/g wet muscle weight)=111.882×absorbance. 111.882 is the dilution factor.

R-Value

R-value measures the ratio of hypoxanthine to nucleotides, and that ratio is an indicator of the rigor state of muscle (Honikel and Fischer, 1977). Duplicate, frozen samples (4 g) were homogenized with 10 mL 0.9 M perchloric acid in a Waring stainless steel mini blender (Model 31BL92, Waring Products Division, Dynamics Corporation of America, New Hartford, Conn.) for 30 sec. The homogenate was filtered through Whatman #1 filter paper. An aliquot of 0.1 mL of the filtrate was diluted into 4.9 mL 0.1 M phosphate buffer, pH 7.0. The absorption at 250 and 260 nm was measured with phosphate buffer as blank. R-value was calculated using the following formula: R-value=Absorbance250/Absorbance 260.

Determination of Nicotinamide-Adenine Dinucleotides

Muscle NAD/NADH metabolism is related to the reduction process, muscle color and the process of glycolysis. In the process of glycolysis, NAD is reduced during the oxidation of glyceraldehyde 3-phosphate to 1,3 bisphosphoglycerate and NADH is oxidized to NAD during the reduction of pyruvate to lactate. The inhibition of glycolysis postmortem could be expected to alter NAD and NADH content depending on the manner in which glycolysis is inhibited. Velazco (1998) hypothesized that inhibition of enolase by sodium fluoride (NaF) might provoke a final reduced state (low NAD/NADH ratio). Results presented herein for the method of the invention were unexpected in that they do not support this hypothesis. Faustman and Cassens (1991) found that gluteus medius contained less NAD and was less color-stable than longissimus muscle. In the results presented herein, control samples had less NAD content than treated ones, although differences in color were insignificant. The less intense red color detected in injected samples may reflect a brine injection effect. Martin-Herrera (1998) also found that flank muscles marinated with calcium fluoride or Sodium fluoride were less red than non-injected muscles.

Nicotinamide-adenine dinucleotide in the oxidated state (NAD) and NADH (the reduced state) were determined by a spectrophotometric absorption method (Klingenberg, 1985), with two different extraction methods. NAD was extracted with acid and NADH with alkali, under suitable conditions.

For NAD extraction, 1 g of powdered, frozen sample and 5 mL of 0.6 N perchloric acid were vigorous stirring with a magnetic stirrer. To remove protein, extracts were centrifuged for 5 min at 3000 to 5000×g. An aliquot of 1 mL of the supernatant was neutralized to pH 7.2-7.4 with 1 N KOH. The reduction of NAD⁺ was quantified by the following reaction: Ethanol+NAD⁺⇄Acetaldehyde+NADH+H⁺. Alcohol dehydrogenase from yeast (No. A3263. Sigma Chemical, St. Louis, Mo.) was used to catalyze the reaction. The concentration was calculated as the change in extinction before and after the enzyme was added at 340 nm wavelength, and multiplied by the dilution factor, following the formula described by Klingenberg (1985).

Alkaline extraction of NADH was performed mixing 2 mL of cold alcoholic potassium hydroxide solution (0.5N) with 200-300 mg of frozen tissue with a stirrer. After 5 min in a 90° C. shake water bath, extracts was neutralized by slow addition of triethanolamine-HCL-phosphate mixture (0.5 M triethanolamine; 0.4 M KH₂PO₄; 0.1 M K₂HPO₄) to bring the pH to 7.8. Extracts were placed at room temperature for 10 min to allow the denatured protein to flocculate, then centrifugation was performed for 5 min at 20,000 to 40,000×g at 4° C. An aliquot of 1 mL was taken immediately for measurements. The lactate dehydrogenase (No. L5432. Sigma Chemical, St. Louis, Mo.) reaction was used for the determination of NADH, as follows: NADH+H⁺+Pyruvate⇄NAD⁺+Lactate.

The quantification of NADH was the same as described for NAD. The increase in extinction due to addition of lactate dehydrogenase from skeletal muscle was followed.

Statistical Analysis

The experimental design was a complete randomized design. Data were analyzed by ANOVA with the General Linear Model procedure of SAS (SAS, 1995). The treatment design was a 3 (muscle type)×5 (treatment) factorial arrangement. The experiment was replicated four times. Means were separated using the Least Significant Difference procedure (Steel and Torrie, 1980), tested on Least Square Means at P<0.05.

Two models were tested. Model I was analyzed as a 3×5 factorial, including data from all muscles (60 observations) and independent variables were: muscle type (3), treatments (5) and the muscle×treatment interaction (3×5 factorial arrangement). The model II was a complete randomized design for each individual muscle type (20 observations) and the independent variable was treatment (5). The muscle×treatment interaction was not significant (P>0.05), therefore results from model II were followed.

### Example 2

### Use of Sodium Citrate to Enhance Tenderness and Palatability of Pre-Rigor Beef Muscles

Experiments were conducted to evaluate the response in Warner-Bratzler shear force and consumer acceptability of muscles pumped pre-rigor with different concentrations of sodium citrate solutions, while maintaining skeletal restraint for 24 hours.

Thoracic limbs from 14 steers were chilled on the carcass (controls) or removed within 2 hours post-mortem and pumped to 10% of muscle weight with water, 200 mM or 400 mM sodium citrate solutions. The injections were performed at various sites along the muscle. The control remained on the carcass. Muscle pH and temperature were measured immediately prior to pumping. Experimental and control muscles were chilled at 2° C. for 24 hours. Steaks (2.54 cm thick) were removed after 24 hours from the Infraspinatus, Supraspinatus and Triceps brachii muscles and were either frozen immediately or aged for another 6 days and then evaluated. A consumer panel evaluated palatability juiciness, tenderness, connective tissue amount, and flavor desirability) on Infraspinatus and Triceps brachii steaks using 9-point hedonic scales (1 being very undesirable and 9 being very desirable) for each trait. Warner-Bratzler shear force values were determined on 1.27 cm-diameter cores from steaks that were broiled to an internal temperature of 70° C.

Treatment with 400 mM sodium citrate improved shear force values over the controls at day 1 and day 7 for all muscles except the Triceps brachii on day 1 (Table 16). Tenderness ratings followed the same trend, except for the Infraspinatus. Connective tissue amount, flavor and juiciness of the 400 mM citrate treated-steaks (Infraspinatus and Triceps brachii) were rated as more desirable (P<0.10) than the controls at day 1 and day 7 (data not shown).

TABLE 15
Shear force and sensory ratings of muscle injected with sodium citrate

| | | | | Triceps brachii | | Supraspinatus | |
|---|---|---|---|---|---|---|---|
| | | Infraspinatus (ISP) | | (TBR) | | (SSP) | |
| Trait | Treatment | d1 | d7 | d1 | d7 | d1 | d7 |
| WBSF | Control | 3.61^{a,b} | 3.50^{b,c} | 3.71^{a} | 3.59^{b} | 5.24^{b} | 4.78^{b} |
| | 0 mM | 3.96^{b} | 3.79^{c} | 4.53^{b} | 4.41^{c} | 5.12^{b} | 4.90^{b} |
| | 200 mM | 3.57^{b} | 3.12^{b} | 3.85^{a} | 3.57^{b} | 4.09^{a} | 3.83^{a} |
| | 400 mM | 3.32^{a} | 2.79^{a} | 3.55^{a} | 3.09^{a} | 3.91^{a} | 4.03^{a} |
| Tenderness | Control | 5.41^{a,b} | 5.52^{a} | 4.69^{b} | 4.64^{b} | | |
| | 0 mM | 4.95^{b} | 4.93^{b} | 3.99^{c} | 4.13^{c} | | |
| | 200 mM | 5.36^{a,b} | 5.68^{a} | 4.81^{b} | | | |
| | 400 mM | 5.67^{a} | 5.90^{a} | 5.25^{a} | 5.48^{a} | | |
| Flavor | Control | 5.18^{a,b} | 4.84^{b} | 5.00^{a} | 4.74^{b} | | |
| | 0 mM | 5.02^{b} | 4.69^{b} | 4.58^{b} | 4.48^{b} | | |
| | 200 mM | 5.33^{a,b} | 5.35^{a} | 5.23^{a} | 4.87^{a} | | |
| | 400 mM | 5.49^{a*} | 5.41^{a} | 5.30^{a*} | 5.18^{a} | | |

a,b,cMeans in the same column within each trait with different superscripts differ significantly (P <.05)
*Control versus 400 mM differ significantly at P<.10

Characteristics of steaks treated with 200 mM sodium citrate were usually between the controls and the 400 mM concentration. Pumping with water was generally detrimental to tenderness and palatability.

These data indicate that a 400 mM sodium citrate solution may be applied to pre-rigor beef muscles (constrained from contraction) to enhance tenderness and palatability.

Evaluation of Color and Microbial Stability

These data indicate that sodium citrate-treated muscles are similar in color with untreated controls after two days of retail display. (Table 16). They start out darker, but quickly come together.

Table 17 indicates that the three muscles differed in their response to the various treatments. Given the differences in fiber type profile, this is to be expected. In general, the 400 mM sodium citrate caused two of the three muscles to be slightly, but significantly, darker than controls (higher L* values). In addition, tables 18 and 19 reveal that the 400 mM-treated samples has similar a* (redness) and b* (green/yellow) values after 1 day of retail display, compared to untreated controls.

Microbial stability is reported in table 21. There were no differences in initial microbial load among the treatments. However, the additional handling needed to inject the muscles resulted in greater overall microbial numbers at day 5 than the uninjected control. Of greatest interest, however, is that treatment with 400 mM sodium citrate showed no greater microbial growth than the control (P>0.05) while the other treatments had greater increases in microbial numbers.

Sarcomere lengths were similar (or longer) for treated muscles than for controls (table 20).

TABLE 16
Visual Color

| Day | Control/carc | Control/water | 200 mM NaCit | 400 mM NaCit |
|---|---|---|---|---|
| 0 | 3.29^{b} | 2.90^{a} | 3.67^{c} | 4.10^{d} |
| 1 | 3.76^{b} | 3.43^{a} | 3.95^{b,c} | 4.24^{c} |
| 2 | 4.19^{b} | 3.24^{a} | 4.10^{b} | 4.29^{b} |
| 3 | 4.14^{b} | 3.38^{a} | 4.19^{b} | 4.33^{b} |
| 4 | 4.10^{b} | 3.19^{a} | 4.14^{b} | 4.29^{b} |
| 5 | 4.43^{b} | 3.48^{a} | 4.14^{b} | 4.29^{b} |

^{a,b,c,d}Means within the same row that have different superscripts are significantly different (p < .05).
A 5-point scale was used: 1 = Pale cherry red, 3 = Bright cherry red, 5 = Dark purple red

TABLE 17
L* Values

| Muscle | Control/carc | Control/water | 200 mM NaCit | 400 mM NaCit |
|---|---|---|---|---|
| ISP | 42.87^{a} | 45.64^{b} | 43.55^{a} | 43.19^{a} |
| SSP | 38.80^{b} | 39.45^{b} | 36.60^{a} | 36.02^{a} |
| TBR | 36.99^{b} | 42.01^{d} | 38.91^{c} | 34.92^{a} |

^{a,b,c,d}Means within the same row that have different superscripts are significantly different (p < .05).

TABLE 18
a* Values

| Day | Control/carc | Control/water | 200 mM NaCit | 400 mM NaCit |
|---|---|---|---|---|
| 0 | 26.64^{a} | 27.47^{a} | 23.92^{b} | 23.94^{b} |
| 1 | 23.28^{b} | 24.56^{a} | 23.44^{a,b} | 23.33^{b} |
| 2 | 21.19^{b} | 23.12^{a} | 22.18^{a,b} | 21.40^{b} |
| 3 | 20.23^{b} | 21.86^{a} | 20.84^{a,b} | 20.66^{b} |
| 4 | 18.64^{b} | 20.69^{a} | 20.11^{a} | 19.87^{a} |
| 5 | 18.79^{b} | 20.32^{a} | 20.80^{a} | 19.73^{a,b} |

^{a,b,c,d}Means within the same row that have different superscripts are significantly different (p < .05).

TABLE 19
b* Values

| Day | Control/carc | Control/water | 200 mM NaCit | 400 mM NaCit |
|---|---|---|---|---|
| 0 | 19.68^{b} | 21.23^{a} | 17.37^{c} | 17.19^{c} |
| 1 | 19.35^{b} | 21.41^{a} | 20.13^{a,b} | 20.14^{a,b} |
| 2 | 18.99^{b} | 21.32^{a} | 19.72^{b} | 18.55^{b} |
| 3 | 18.92^{b} | 21.05^{a} | 19.22^{b} | 18.84^{b} |
| 4 | 17.97^{b} | 20.33^{a} | 18.79^{b} | 18.25^{b} |
| 5 | 18.90^{b} | 20.37^{a} | 19.90^{a,b} | 19.34^{a,b} |

^{a,b,c,d}Means within the same row that have different superscripts are significantly different (p < .05).

TABLE 20
Sarcomere Length Values

| Muscle | Control/carc | Control/water | 200 mM NaCit | 400 mM NaCit |
|---|---|---|---|---|
| ISP | 1.97^{a} | 2.25^{a} | 2.04^{a} | 2.09^{a} |
| SSP | 2.06^{b} | 2.76^{a} | 2.42^{a} | 2.53^{a} |
| TBR | 2.57^{a} | 2.26^{a} | 2.35^{a} | 2.40^{a} |

^{a,b,c,d}Means within the same row that have different superscripts are significantly different (p < .05).

TABLE 21
Logarithmic Microbiological Growth Values

| Muscle | Control/carc | Control/water | 200 mM NaCit | 400 mM NaCit |
|---|---|---|---|---|
| day 0 | 2.08 | 2.51 | 2.58 | 2.72 |
| day 5 | 3.59^{a} | 5.70^{b} | 5.45^{b} | 5.11^{b} |
| differ- | 1.50^{a} | 3.21^{b} | 2.88^{b} | 2.40^{a,b} |
| ence | | | | |

^{a,b,c,d}Means within the same row that have different superscripts are significantly different (p < .05).

### Example 3

### Preparing the Muscle for Treatment

In preparation for treatment of the pre-rigor muscle with the compositions of the invention, the muscle may be manually or mechanically removed from the skeleton. Alternatively, the entire carcass, or a portion thereof, could be treated with the muscle fully or partially attached to the skeleton.

General methods for treatment of muscle may be applied before or after application of the invention. Such methods might include, but are not limited to, the application of refrigeration, freezing, or other methods of temperature reduction. Steps might also be taken to alter the biochemical state of the muscle, like electrical stunning of the animal, electrical stimulation of the carcass or muscle, or other physical/mechanical manipulation (including tumbling and/or massaging with or without vacuum). Additionally or alternatively, it may be desired to reduce muscle size. This could occur by grinding, slicing, macerating, chipping, flaking, cutting or other conventional methods which could occur before, during, or after the above-described treatments. Other general commercial applications may be employed, such as procedures to open the muscle structure through cutting, macerating, puncturing, pumping, extruding, or similar strategies known in the art.

Application of solutions containing water and/or other ingredients may also be used to retain, augment, enhance or simultaneously improve tenderness. These solutions may be applied in advance of, in conjunction with, or subsequent to application of the invention.

### Example 4

### Methods of Application

The compositions of the invention can be applied through direct injection into the muscle (pumping). This can be done manually or mechanically. Meat treated in such a matter could be expected to gain 3%-40% of its weight through such a method. Typically, the concentration of the compositions of the invention is established in part through a calculation of the amount of solution to be pumped into the meat and the net gain in weight expected to occur—as influenced by subsequent processing factors like dwell time, drain time, packaging, cooking or other factors. Since the concentration of the compositions of the invention which can be used in a given manufacture of meat or meat product can vary considerably with the specific pre-treatment method of application/post-application processing of the manufacture, the range of concentrations used in the method of the instant invention include from about 0.1% to about 40%.

An alternative or supplement to pumping is marination of the meat in a solution containing some or all of the compositions of the invention. This can occur in conjunction with other ingredients, like salt and phosphates, among others. The marination (or steeping) can occur for a definite period of time or indefinitely and may or may not be programmed for a particular temperature and pressure.

Another technique to deliver the compositions of the invention to the muscle would be by artery or vein injection, whereby the vascular system of the muscle is used to help distribute the solution containing the invention (alone or in combination with others) into the muscle. This approach can include infusion into the animal body. A high-pressure spray and/or a vacuum system may be part of the delivery mechanism.

### Example 5

### Post-Application Processing

A number of post-application processing steps may be applied individually or in combination to meat treated with the compositions of the invention to retain or enhance the effects thereof. A time delay after treatment can be implemented for a number of reasons, including to retain or enhance effects of the invention, provide time for additional processing procedures, and/or for distribution. This time delay can range in duration from minutes to days. Tumbling and/or massaging (ranging from minutes to several hours) can be used, alone or in conjunction with other physical/mechanical manipulation such as described in Examples 3 and 4 and a post-treatment marinade (as described in Example 4) may be applied. Additionally, temperature manipulation can be applied. This could range from freezing and refrigeration to pre-cooking or cooking. A combination of these strategies would likely be used.

Products treated with the invention can be packaged in a variety of ways. It is possible for features of the packaging to retain or enhance application and/or effectiveness of the invention. For example, vacuum packaging can enhance uptake of a marinade. The package can help ensure the added solution remains within the meat (rather than draining out of the muscle). Some packages are designed for cooking of product within (e.g., bone-in-the-bag package) and thus can enhance effectiveness as previously described.

Other post-treatment procedures can include size reduction (as described in Example 3) and/or combination with other common processing steps, such as treatment with other ingredients.

### Example 6

### Enhancing Tenderness of Skeletal Muscle from Other Species

From a manufacturing perspective, different muscles types behave in a similar manner. For example, virtually all of the meat processing equipment in the industry works on meat from any species (with the possible exception of fish). The grinders, mixers, stuffers, and tumblers used in a poultry meat operation are often identical to equipment used for beef or pork. Thus, it is appropriate to extrapolate these results to all striated, skeletal muscle. Biochemistry of muscle is consistent across species to such an extent that the focus is on the few subtle differences rather than the similarities among muscle types. The post-mortem biochemistry of all striated, skeletal muscle is similar. They rely on glycolysis (the degradation of endogenous glycogen) to generate energy (ATP) within the muscle during rigor, thereby producing lactic acid and dropping muscle pH. The same biological structures exist—at both the cellular as well as the tissue level. Given the common biochemistry of striated skeletal muscles, similar results are to be expected with skeletal muscle, including muscle of pork, lamb, poultry, bison and liama.

While the invention has been disclosed in this patent application by reference to the details of preferred embodiments of the invention, it is to be understood that the disclosure is intended in an illustrative rather than in a limiting sense, as it is contemplated that modifications will readily occur to those skilled in the art, within the spirit of the invention and the scope of the appended claims.

LIST OF REFERENCES

Aalhus et al. (1994). Food Res. Int. 27:513-518.

Ahn et al. (1989). Poultry Sci. 68:1088-1099.

Ahn et al. (1992). Meat Sci. 32:65-79.

Alvarez (1996). Instituto Technológico y de Estudios Superiores de Monterrey, Monterrey-Mexico.

AMSA (1995). Research Guidelines for Cookery, Sensory Evaluation and Instrumental Tenderness Measurements of Fresh Meat. Am. Meat Science Assoc., Chicago, Ill.

Ashmore (1974). J. Anim. Sci. 38:1158-1158[?].

Ashmore et al. (1972). J. Anim. Sci. 34:46-48.

Atkinson et al. (1973). J. Food Technol. 8:51-58.

Atkinson et al. (1969). Nature 223:1372-1973.

Beltrán et al. (1997). Meat Sci. 45:201-207.

Bendall (1972). J. Sci. Food Agric. 23:61-72.

Benito-Delgado et al. (1994). J. Food Sci. 59:295-299.

Bernthal et al. (1989). Meat Sci. 25:143-154.

Bernthal et al. (1991). Meat Sci. 29:69-82.

Boleman et al. (1995). Meat Sci. 39:35-41.

Boles et al. (1997). Meat Sci. 45:87-97.

Bouton et al. (1973). J. Food Sci. 38:932-937.

Brooke et al. (1970). Arch. Neurol. 23:369-379.

Calkins et al. (1981). J. Food Sci. 46:708-710.

Calkins et al. (1999). Nebraska Beef Report, pp. 72-74.

Cassens et al. (1971). Adv. Food Res. 19:1-74.

Carpenter et al. (1961). Food Technol. 4:197-198.

Clarenburg (1991). PHYSIOLOGICAL CHEMISTRY OF DOMESTIC ANIMALS (1st ed.), Mosby-year Book, Inc., St. Louis, Mo.

Cornforth et al. (1985). J. Food Sci. 50:1021-1024, 1028.

Cornforth et al. (1980). J. Anim. Sci. 50:75-80.

Cross et al. (1981). Meat Sci. 5:261-266.

Cross et al. (1980). J. Food Sci. 45:765-768.

Culler et al. (1978). J. Food Sci. 43:1177-1180.

Dalrymple et al. (1973). J. Food Technol. 8:439-444.

Dalrymple et al. (1974). J. Food Sci. 39:1218-1220.

Dalrymple et al. (1975). J. Food Sci. 40:850-853.

Davis et al. (1979). J. Anim. Sci. 49:103-114.

Dayton et al. (1981). The role of muscle proteolytic enzymes in degradation of the myofibril. In: Proc. 34th. Recip. Meat Conf., AMSA-National Life Stock and Meat Board. Chicago, Ill. pp. 17-23.

Echevarne et al. (1990). Meat Sci. 27:161-172.

Egbert et al. (1986). J. Food Sci. 51:57-60.

Eilers et al. (1994). Meat Sci. 38:443-451.

Faustman et al. (1990). J. Food Sci. 55:1278-1283.

Faustman et al. (1991). J. Anim. Sci. 69:184-193.

FDA (1999). Food and Drug Administration home page. Available at: http://www.cfsan.fda.gov/˜Ird/foodadd.htm. Accessed Oct. 24, 1999.

Fisher et al. (1981). POSTMORTEM MUSCLE BIOCHEMISTRY AND BEEF QUALITY. In: Hood, D. E., and P. V. Tarrant (Eds.). The problem of dark-cutting in beef, pp. 387-390. Martinus Nijhoff Publishers. The Hague, Germany.

Goll et al. (1992). J. Food Sci. 57:834-840.

Goll et al. (1983). J. Food. Biochem. 7:137-141.

Greaser (1986). CONVERSION OF MUSCLE TO MEAT. In: Bechtel, P. J. (Ed.). Muscle as Food, pp. 46-102. Academic Press, New York, N.Y.

Hamm (1977). Meat Sci. 1:15-39.

Hamm (1982). Food Technol. 11:105-115.

Hamm (1986). FUNCTIONAL PROPERTIES OF THE MYOFIBRILLAR SYSTEM AND THEIR MEASUREMENTS. In: P. J. Bechtel (Ed.) Muscle as Food, pp. 135-136. Academic Press, Inc., Florida.

Harrell et al. (1978). J. Anim. Sci. 46:1592-1596.

Hertzman et al. (1993). Meat Sci. 35:119-141.

Honikel et al. (1977). J. Food Sci. 42:1633-1636.

Honikel et al. (1981). J. Food Sci. 46:23-25, 31.

Hostetler et al. (1972). J. Food Sci. 37:132-135.

Hunt et al. (1977). J. Food Sci. 42:513-517.

Jauregui et al. (1981). J. Food Sci. 46:1271-1273.

Jeremiah et al. (1991). Meat Sci. 30:97-114.

Jones et al. (1994). J. Anim. Sci. 72:1492-1501.

Kamstra et al. (1959). Food Technol. 11:652-654.

Kastenschmidt et al. (1968). J. Food Sci. 33:151-158.

Kastner et al. (1975). J. Food Sci. 40:747-750.

Khan et al. (1971). Can. Inst. Food Technol. 4:139-142.

Klingenberg (1985). NICOTINAMIDE-ADENINE DINUCLEOTIDES AND DINUCLEOTIDE PHOSPHATE. In: Bergmeyer, H. V. (Ed.) Methods of Enzymatic Analysis (3^{rd} ed.). Vol 7. pp 251-260. Verlag Chemie. Deerfield Beach, Fla.

Koohmaraie et al. (1988). J. Food. Sci. 53:1638-1641.

Koohmaraie et al. (1989). J. Anim. Sci. 67:934-942.

Koohmaraie (1990). J. Anim. Sci. 68:659-665.

Koohmaraie (1990). J. Anim. Sci. 68:1278-1283.

Koohmaraie (1991). J. Anim. Sci. 69:2463-2471.

Koohmaraie (1996). Meat Sci. 43: S193-S201.

Koohmaraie (1996). J. Anim. Sci. 74:2935-2942.

Lamkey et al. (1993). J. Muscle Foods 4:193-206.

Lansdell (1995). J. Anim. Sci. 73:1735-1739.

Lawrie (1998). MEAT SCIENCE (6th Ed.). Woodhead Publishing Limited. Cambridge. England.

Ledward (1985). Meat Sci. 15:149-171.

Lister (1970). “The effects of pre-slaughter injection of magnesium sulphate on glycolysis and meat quality in the steer.” In: Proc. 16^{th} Eur. Meeting Meat Res. Workers. pp. 255-262. Meat Technology Research and Project Institute-SOFIA, Varna, Bulgaria.

Locker et al. (1963). J. Sci. Food Agric. 14:787-793.

Marsh et al. (1974). Food Technol. 9:129-139.

Marsh (1987). Meat Sci. 21:241-248.

Martin-Herrera (1998). “Effect of prerigor marination using calcium chloride, calcium fluoride, or sodium fluoride on shear force and quality traits of excised beef rectus abdominis and sternomandibularis muscles.” Masters Thesis. Kansas State Univ., Manhattan, Kans.

Meade et al. (1992a). J. Food Sci. 57:1038-1040, 1045.

Meade et al. (1992 b). J. Food Sci. 57:1041-1045.

Montilva (1993). J. Food Biochem. 16:207-215.

Montville (1982). J. Food Sci. 47:1879-1882.

Morgan et al. (1991 a). J. Anim. Sci. 69: 3274-3283.

Morgan et al. (1991 b). J. Anim. Sci. 69: 4469-4476.

Newbold et al. (1967). Biochem. J. 105:127-136.

Oblinger et al. (1973). J. Food Sci. 38:1108-1112.

Offer et al. (1989). “The structural basis of water-holding in meat.” In: Lawrie, R. A. (Ed). Developments in Meat Science. Vol. 4 pp 173-243. Elsevier Appli. Sci. London, England.

O'Keefe et al. (1982). Meat Sci. 7:209-228.

Olsson et al. (1994). Meat Sci. 37:115-131.

Orcutt et al. (1984). J. Anim. Sci. 58:1366-1375.

Ouali et al. (1990). Meat Sci. 28:331-348.

Papadopoulos (1991). J. Food Sci. 3:621-626, 635.

Pearson et al. (1973). J. Food Sci. 38:1124-1127.

Pike et al. (1993). Meat Sci. 34:13-26.

Pisula et al. (1996). Meat Sci. 43: S125-S134.

Pringle et al. (1997). J. Anim. Sci. 75:2955-2961.

Purchas (1990). Meat Sci. 27: 203.

Renerre (1990). International J. Food Sci. Technol 25:613-630.

Renerre et al. (1987). Meat Sci. 19:151-165.

Rödel et al. (1999). Fleischwirtschaft International 1:38-41.

Roehrig et al. (1974). Anal. Biochem. 58: 414-421.

SAS. 1995. User's Guide: Statistics. SAS Institute, Inc., Cary. N.C.

Savell et al. (1989). J. Food Qual. 12:251-274.

Shackelford et al. (1994a). Meat Sci. 37:195-204.

Shackelford et al. (1 994b). J. Anim. Sci. 72:337-343.

Schmidt et al. (1970). J. Food Sci. 35:574-576.

Seideman et al. (1987). Meat Sci. 20:281-291.

Severin et al. (1963). Biochem. J. 28:112-118.

Smith et al. (1979). J. Food Sci. 44:158-163.

Smulders et al. (1990). Meat Sci. 28:349-363.

Stanton et al. (1990). Meat Sci. 27:141-159.

Steel et al. (1980). PRINCIPLES AND PROCEDURES OF STATISTICS: A BIOMETRICAL APPROACH (2^{nd} Ed.). Mcgraw-Hill Publishing Co., New York, N.Y.

Stryer (1996). BIOCHEMISTRY. (4^{th} Ed.). W. H. Freeman and Company, New York, N.Y.

Takahashi (1996). Meat Sci. 43:S67-S80.

Talmant et al. (1986). Meat Sci. 18:23-40.

Tarrant (1977). J. Sci. Food Agric. 28:927-930.

Tarrant (1998). Meat Sci. 49: S1-S166.

Taylor et al. (1995). Anim. Sci. 73:1351-1367.

Totland et al. (1988). Meat Sci. 23:303-315.

U.S. Dept. of Agriculture, Office of Policy, Program Development and Evaluation (1998). FOOD STANDARDS AND LABELING POLICY BOOK.

Unruh et al. (1986). Meat Sci. 18:281-293.

Urinch (1994). COMPARATIVE ANIMAL BIOCHEMISTRY. Springer-Verlag, New York, N.Y. pp. 722-724.

Valin et al. (1982). Meat Sci. 6:257-263.

Van Laack et al. (1998). J. Muscle Foods 9:185-191.

Velazco (1998). PERSONAL COMMUNICATION. Dept. of Food Technology, Monterrey Tech., Mty, NL. Mexico.

Watanabe et al. (1996). Meat Sci. 42: 67-78. Weeb (1974). ENZYME AND METABOLIC INHIBITORS. In: H. V. Bergmeyer (Ed.) Methods of Enzymatic Analysis (2^{nd} ed.). Vol 3. Academic Press, Inc., New York, N.Y.

Wheeler et al. (1991). J. Anim. Sci. 69:4871-4875.

Wheeler et al. (1992). J. Anim. Sci. 70:3451-3457.

Wheeler et al. (1993). J. Anim. Sci. 71:2965-2972.

Wheeler et al. (1994). REDUCING INCONSISTENT BEEF TENDERNESS WITH CALCIUM-ACTIVATED TENDERIZATION. Proc. Meat Industry Res. Conf., pp. 119-121.

Wheeler et al. (1996). J. Anim. Sci. 74:1846-1853.

Wheeler et al. (1997). J. Anim. Sci. [VOL?]:2652-2659.

Wheeler et al. (1999). J. Anim. Sci. 77:2444-2451.

Williamson (1965). J. Biol. Chem. 240:2308-2321.

Winger et al. (1979). J. Food Sci. 44:1681-1685.

Wu et al. (1987). J. Anim. Sci. 65:597-608.

Wulf et al. (1997). J. Anim. Sci. 75:684-692.

Young (1982). Biochem. J. 203:179-185.

Young (1984). Meat Sci. 11:123-137.

Young et al. (1984). Meat Sci. 11:159-170.

Young et al. (1988). Meat Sci. 23:211-225.

Yu et al. (1986). J. Food Sci. 51:774-780.

Zubay (1988). BIOCHEMISTRY (2^{nd} ed). MacMillan Publishing Co. New York. N.Y.

We claim:

1. A method of enhancing tenderness of animal meat comprising:
a) slaughter and eviscerate said animal,
b) excise pre-rigor skeletal muscle of said animal,
c) apply a composition to said excised skeletal muscle,
wherein said application comprises injection of said composition into the skeletal muscle and wherein said composition comprises solutions of compounds selected from the group consisting of citric acid, a salt of citric acid, glucose, sodium oxalate, oxamic acid, sodium acetate and combinations thereof.

2. The method of claim 1, wherein said compound is in solution at a concentration of about 0.1% to about 10%.

3. The method of claim 1, wherein said compound is in solution at a concentration of about 0.5% to about 8%.

4. The method of claim 1, wherein said compound is in solution at a concentration of about 0.5% to about 5%.

5. The method of claim 2, wherein the weight of said solution is equal to about 3% to about 40% of the weight of said excised skeletal muscle.

6. The method of claim 2, wherein the weight of said solution is equal to about 3% to about 20% of the weight of said excised skeletal muscle.

7. The method of claim 1, wherein said composition is citric acid.

8. The method of claim 1, wherein said compound is a salt of citric acid.

9. The method of claim 8, wherein said compound is sodium citrate.

10. The method of claim 1, wherein said compound is glucose.

11. The method of claim 1, wherein said compound is sodium oxalate.

12. The method of claim 1, wherein said compound is oxamic acid.

13. The method of claim 1, wherein said compound is sodium acetate.

14. The method of claim 1, wherein said animal meat is selected from the group consisting of beef, pork, lamb, poultry, deer, bison and llama.

15. A method enhancing tenderness of animal meat comprising:
a) slaughter and eviscerate said animal,
b) maintain skeletal restraint of pre-rigor skeletal muscle of said animal,
c) apply a composition to said pre-rigor skeletal muscle,
d) excise said skeletal muscle,
wherein said application comprises injection of said composition into the pre-rigor skeletal muscle, and wherein said composition comprises solutions of compounds selected from the group consisting of citric acid, a salt of citric acid, glucose, sodium oxalate, oxamic acid, sodium acetate and combinations thereof.

16. The method of claim 15, wherein said compound is included in the solution at a concentration of about 0.1% to about 10%.

17. The method of claim 15, wherein said compound is included in the solution at a concentration of about 0.5% to about 8%.

18. The method of claim 15, wherein said compound is included in the solution at a concentration of about 0.5% to about 5%.

19. The method of claim 16, wherein the weight of said solution is equal to about 3% to about 40% of the weight of said excised skeletal muscle.

20. The method of claim 16, wherein the weight of said solution is equal to about 3% to about 20% of the weight of said excised skeletal muscle.

21. The method of claim 15, wherein said composition is citric acid.

22. The method of claim 15, wherein said compound is a salt of citric acid.

23. The method of claim 22, wherein said compound is sodium citrate.

24. The method of claim 15, wherein said compound is glucose.

25. The method of claim 15, wherein said compound is sodium oxalate.

26. The method of claim 15, wherein said compound is oxamic acid.

27. The method of claim 15, wherein said compound is sodium acetate.

28. The method of claim 1, wherein said animal meat is selected from the group consisting of beef, pork, lamb, poultry, deer, bison and llama.

29. A method of enhancing tenderness of animal meat comprising:
a) slaughter and eviscerate said animal,
b) excise pre-rigor skeletal muscle of said animal,
c) apply a composition to said excised skeletal muscle,
wherein said application comprises marination in said composition, and wherein said composition comprises solutions of compounds selected from the group consisting of citric acid, a salt of citric acid, glucose, sodium oxalate, oxamic acid, sodium acetate and combinations thereof.

30. The method of claim 29, wherein said compound is in solution at a concentration of about 0.1% to about 20%.

31. The method of claim 29, wherein said compound is in solution at a concentration of about 0.5% to about 15%.

32. The method of claim 29, wherein said composition is citric acid.

33. The method of claim 29, wherein said compound is a salt of citric acid.

34. The method of claim 33, wherein said compound is sodium citrate.

35. The method of claim 29, wherein said compound is glucose.

36. The method of claim 29, wherein said compound is sodium oxalate.

37. The method of claim 29, wherein said compound is oxamic acid.

38. The method of claim 29, wherein said compound is sodium acetate.

39. The method of claim 29, wherein said animal meat is selected from the group consisting of beef, pork, lamb, poultry, deer, bison and llama.

40. The method of claim 1, wherein said injection comprises direct injection into the said excised skeletal muscle.

41. The method of claim 1, wherein said injection comprises methods selected from the group consisting of injection into a vein, into an artery, by perfusion and combinations thereof.

42. The method of claim 15, wherein said injection comprises direct injection into the said excised skeletal muscle.

43. The method of claim 15, wherein said injection comprises methods selected from the group consisting of injection into a vein, into an artery, by perfusion and combinations thereof.

44. The meat prepared by the method of claim 1.

45. The meat prepared by the method of claim 15.

46. The meat prepared by the method of claim 29.
